(19) United States
(12) Patent Application Publication
(10) Pub. No.: US 2006/0199890 A1
(43) Pub. Date: Sep. 7, 2006

(54) Nanocomposites including modified fillers

(75) Inventors: Paula D. Fasulo, Eastpointe, MI (US); William R. Rodgers, Bloomfield Tup, MI (US); Robert A. Ottaviani, Anthem, AZ (US); Douglas L. Hunter, Harwood, TX (US); Antonio Gonzales, Gonzales, TX (US)

Correspondence Address: MEYERTONS, HOOD, KIVLIN, KOWERT & GOETZEL, P.C., 700 LAVACA, SUITE 800, AUSTIN, TX, 78701, US

(73) Assignee: Southern Clay Products, Inc.

(21) Appl. No.: 11/070,833

(22) Filed: Mar. 2, 2005

(51) Int. Cl. C08K 9/04

(52) U.S. Cl. 524/445

(57) ABSTRACT

A nanocomposite material includes at least one polymeric material and at least one modified nanofiller material having shielded polar groups, wherein the at least one polymeric material is compatible with the modified nanofiller without an external compatibilizing material. The nanocomposite material advantageously exhibits enhanced physical properties.

### BACKGROUND

The present disclosure generally relates to nanocomposites, and more particularly to nanocomposites incorporating modified fillers therein.

Nanotechnology can be defined as materials or devices engineered at the molecular level. Within this category are polymer nanocomposites, which are a class of materials that use molecular sized particles for reinforcing the polymer matrix, the particles having one or more dimensions on a sub-micrometer scale. These materials blend an organoclay with polymer to produce a composite with equal or better physical and mechanical properties than their conventionally filled counterparts, but at lower filler loadings.

Due to the surface area available with nano-fillers, polymer nanocomposites offer the potential for enhanced mechanical properties, barrier properties, and thermal properties when compared to conventionally filled materials.

One class of polymer nanocomposites uses a filler material that is based on the smectite class of aluminum silicate clays, a common representative of which is montmorillonite. Although naturally occurring and synthetic variations of this basic mineral structure can be used to make nanocomposites, if property enhancements are to be achieved, the structure allows the exchange of interlayer inorganic cations, such as Na⁺ or Ca²⁺, with organic cations, such as alkylammonium cations. The silicate platelets consist of a central octahedral aluminate structure surrounded on either side with a tetrahedral silicate structure. Iron or magnesium occasionally replaces an aluminum atom, rendering an overall negative charge. This charge is counterbalanced by the inorganic cations which reside between the sheets, holding them loosely together. The exchange of interlayer inorganic cations with organic cations increases the spacing between the silicate sheets, as well as improves the compatibility of the filler and the resin system, thereby facilitating exfoliation.

When exfoliated properly, these layered silicates have size dimensions approximately 1 nm thick by 50 to 2000 nm long. This leads to aspect ratios on the order of 50 to 2000. This value is extremely high compared to the aspect ratio of conventional fillers such as talc (aspect ratio ˜1) and glass fibers (aspect ratio ˜20). Because of this high aspect ratio, there is the potential to obtain properties equal to or greater than conventionally filled materials but at much lower filler loadings of about 2% to 5%. Conventionally filled materials require about 20% to 30% loadings to achieve equivalent property enhancement.

Early polyolefin nanocomposite materials were prepared by the melt processing method. This was a cladding grade material which needed an external compound to compatibilize the non-polar matrix with the polar filler. This compatibilizer is generally a polypropylene-based material containing about 1% maleic anhydride that is added at about a 5% level to the nanocomposite, thus significantly increasing cost.

### SUMMARY

In an embodiment, a nanocomposite material is formed that includes at least one polymeric material and at least one modified nanofiller material having shielded polar groups, wherein the polymeric material(s) is compatible with the modified nanofiller material without an external compatibilizing material. The nanocomposite material advantageously exhibits enhanced physical properties.

### BRIEF DESCRIPTION OF THE DRAWINGS

Advantages of the present disclosure will become apparent to those skilled in the art with the benefit of the following detailed description of embodiment and upon reference to the accompanying drawings, in which:

FIG. 1 is a TEM Micrograph Of A Non-Silane-Treated Clay Filled Nanocomposite;

FIG. 2 is a TEM Micrograph Of A Silane-Treated Clay Filled Nanocomposite;

FIG. 3 is a TEM Micrograph Of A Non-Silane-Treated Clay Filled Nanocomposite at a Higher Magnification;

FIG. 4 is a TEM Micrograph Of A Silane-Treated Clay Filled Nanocomposite at a Higher Magnification; and

FIG. 5 is a bar graph depicting change in flexural modulus as a function of inorganic content of the nanocomposite for nanocomposites made with different amounts of silanated clay compositions embodied herein.

While the present disclosure is susceptible to various modifications and alternative forms, specific embodiments thereof are shown by way of example in the drawings and will herein be described in detail. It should be understood that the drawing and detailed description thereto are not intended to limit the disclosure to the particular form disclosed, but on the contrary, the intention is to cover all modifications, equivalents and alternatives falling within the spirit and scope of the present disclosure as defined by the appended claims.

### DETAILED DESCRIPTION

Thermoplastic materials are generally the material of choice for vehicle cladding and fascia systems, and may soon become the preferred materials for all body panels and interior systems. Nanocomposites, which are a relatively new class of materials that use molecular-sized particles for reinforcing the polymer matrix, are some of the thermoplastic materials evaluated by the current inventors. These materials generally blend an organoclay nanofiller with polyolefins to produce a composite with substantially improved physical and mechanical properties.

It has been discovered that, for optimal reinforcement properties in nanocomposite materials, good exfoliation of incorporated nanofiller is desirable. Further, good dispersion of the layers of the nanofiller (e.g. the silicate layers) throughout the resin and good compatibility between the polymer resin(s) and the filler(s) are also desirable.

Preparation of polyolefin nanocomposites to date usually required the use of an external compatibilizer. This compatibilizer generally has a significant impact on properties such as flexural modulus and coefficient of linear thermal expansion, but is a relatively expensive addition to the formulation(s).

According to embodiment(s) described herein, it has been fortuitously and unexpectedly discovered that a novel nanocomposite material exhibiting enhanced physical properties may be formed by mixing a modified nanofiller material having shielded polar groups with a monomer and/or polymer system. As used herein, the term “nanofiller” generally refers to a particulate filler or additive whose particle dimensions are generally in the nanometer range. Nanofillers may include clay and/or organoclay compositions. Modified nanofillers may include silanated clay and/or silanated organoclay compositions. In an embodiment, the monomer and/or polymer system may be substantially compatible with the modified nanofiller having shielded polar groups, which results in the nanofiller being compatible with the monomeric/polymeric material of choice without an external compatibilizing material. This is advantageous in that the novel nanocomposite material is generally less costly than those nanofilled materials requiring incorporation of an external compatibilizing material. These novel nanofilled materials without compatibilizers exhibit substantially the same or better physical properties than those nanofilled materials with compatibilizers.

A nanocomposite material according to an embodiment includes one or more polymeric materials and one or more modified nanofiller materials having shielded polar groups, wherein the polymeric material(s) is compatible with the modified nanofiller without an external compatibilizing material. The nanocomposite material exhibits enhanced physical properties, such as, for example, flexural modulus and coefficient of linear thermal expansion. In addition to enhanced physical properties, it has been discovered that using these modified nanofillers without an external compatibilizer generally prevents undesirable agglomeration of the filler materials during processing, thereby further substantially improving the surface of the molded nanocomposite materials, resulting in a molded surface substantially without unacceptable surface imperfections.

Nanofiller materials having shielded polar groups may include clay and/or organoclay materials in which at least a portion of the polar groups of the clay and/or organoclay (e.g., hydroxyl groups) have been reacted with an organic molecule. The formation of a shielded polar group (one example of which is a shielded hydroxyl group), i.e. masking the polarity of the polar group by an organic ligand, may be accomplished via any of a number of chemical reactions.

In one embodiment, reactions of polar groups with silyl halides or silyl ethers of the general form RₙSiX₍₄₋ₙ₎, wherein n represents an integer from 1 to 3; R represents an alkyl group, an aryl group, an alkylaryl group, a vinyl group, an allyl group, an alkylamino group, an arylamino group, or organic moieties that may contain ketone, ester, ether, organosulfur or carboxyl groups, or combinations thereof; and wherein X represents an alkoxy group, an aryloxy group, an amino group, hydrogen, a halogen, or combinations thereof, result in shielded polar groups. The resulting shielded polar group from this reaction(s), if, for example, the nanofiller material were montmorillonite clay, would be of the general form Mont₍₄₋ₙ₎SiRₙ, where Mont represents the edge of the montmorillonite sheet.

Other suitable shielding reactions are reactions of polar groups with organic acids of the formula RC(O)OH or acid chlorides of the general formula RC(O)Cl to form an ester. For example, if the nanofiller material were montmorillonite clay, the resulting shielded nanofiller material would have the general structure Mont-OC(O)R, wherein R is an alkyl group, aryl group, alkylaryl group, or combinations thereof.

Yet other suitable shielding reactions are reactions of polar groups with isocyanates of the general form RNCO to form the urethane. For example, if the nanofiller material were montmorillonite clay, the resulting shielded nanofiller material would have the general structure Mont-OC(O)NR, wherein R is an alkyl group, aryl group, alkylaryl group, or combinations thereof.
Further possible shielding reactions are:

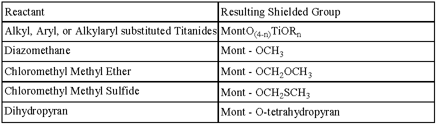

It is to be understood that the montmorillonite clay example, used in these examples immediately above, is for illustrative purposes, and that any of the suitable nanofiller materials described herein may be used in the reaction(s) listed above to shield the nanofiller material polar groups.

Analysis that the shielding reaction has taken place (i.e., that at least a portion of the respective polar groups on the nanofiller material are shielded) may be done through spectroscopic means, for example, with infrared (IR) spectroscopy or nuclear magnetic resonance (NMR) spectroscopy, analyzing for the organic groups present on the modified nanofiller material after the reaction has taken place.

Another method to test that the shielding reaction has taken place is to measure the change in the surface energy of the nanofiller material using the sessile drop contact angle method. The contact angle of the nanofiller material after treatment will decrease if the contacting fluid is non-polar (e.g., decane), showing that the edge polar groups have been shielded.

Yet another method to test that the shielding reaction has taken place is to check the dispersability of the nanofiller material in a non-polar solvent. The nanofiller material will disperse better in a non-polar solvent after the shielding reaction than prior to the reaction.

It is to be understood that the nanocomposite material(s) according to embodiments described herein may be suitable for many applications. One non-limitative example of such an application includes use as an automotive interior body material and/or an automotive exterior body material.

It is to be understood that the polymeric materials may be chosen from any suitable materials. In an embodiment, the polymeric materials are thermoplastic materials. It is to be further understood that any suitable thermoplastic materials may be used. In an embodiment, the thermoplastic materials include, but are not limited to polypropylenes, polyethylenes, polystyrenes, polyethyleneterephthalate (PET), polymethylmethacrylate, polycarbonates, polyurethane, poly(acrylonitrile-co-butadiene-co-styrene) (ABS) (and its variants, e.g. poly(acrylonitrile-co-styrene-co-acrylate) (ASA), poly(styrene-co-butadiene-co-styrene) (SBS), and polycarbonate-poly(acrylonitrile-co-butadiene-co-styrene) (PC-ABS)), polyacetals, polyacrylics, polyacrylonitriles, polyesters, fluoropolymers, polyacrylates, polybutadienes, polyvinyl chlorides, high-impact polystyrenes, poly(styrene-co-maleic anhydrides), cellulose acetates, cellulosics, ionomers, poly(ethylene vinyl alcohol), poly(ethylene vinyl acetate), monomers suitable to form the above-listed polymers, and/or the like, and/or mixtures thereof.

In a further embodiment, the polymeric materials are thermoplastic materials including thermoplastic olefins (TPOs). It is to be further understood that any suitable thermoplastic olefins may be chosen. In an embodiment, the thermoplastic olefins include at least one of polypropylenes, polyethylenes, elastomers, impact copolymers thereof, monomers suitable to form the above-listed polymers, and/or mixtures thereof. In a further embodiment, the thermoplastic olefins include at least one of polypropylene homopolymers, impact modified polypropylenes, ethylene-propylene elastomers, monomers suitable to form the above-listed polymers, and/or mixtures thereof. Non-limitative embodiments of suitable commercially available polymeric materials are listed in Table I (below) under the labels “Polypropylenes,” “Propylene Copolymers” and “Elastomers.”

It is to be understood that the modified nanofiller may be any suitable modified nanofiller material. In an embodiment, the modified nanofiller is a modified clay which is at least one of smectite, hectorite, montmorillonite, bentonite, beidelite, saponite, stevensite, sauconite, nontronite, illite, and/or mixtures thereof.

In an embodiment, the modified nanofiller is a clay modified with an active silane material of the general formula, RₓSi(OR′)₄₋ₓ, where R is an appropriate organic substituent for compatibility with the resin/polymeric material(s) of choice, and the active silane material contains at least one group capable of undergoing hydrolysis for reaction with hydroxyl materials. In an embodiment, non-limitative examples of R include methyl, ethyl, phenyl, n-octyl, n-octadecyl, 2-ethylhexyl, n-dodecyl, and/or the like, and/or mixtures thereof. It is to be understood that R′ may be the same as, or different from R. In an embodiment, non-limitative examples of R′ include methyl, ethyl (these groups may advantageously ease separation after reaction, that is, after reaction these groups become alcohols (methanol and ethanol) and are relatively easy to remove), isopropyl, n-butyl, isobutyl, and/or the like, and/or mixtures thereof.

In an alternate embodiment, the modified nanofiller is a silanated aluminum silicate smectite clay. In yet a further embodiment, non-limitative examples of the modified nanofiller include at least one of sodium montmorillonite treated with phenyltriethoxysilane, sodium montmorillonite treated with n-octadecyltriethoxysilane, sodium montmorillonite treated with n-octyltriethoxysilane, and/or mixtures thereof.

In an embodiment, the nanocomposite material has a flexural modulus ranging between about 814 MPa and about 2144 MPa. In an alternate embodiment, the nanocomposite material has a flexural modulus ranging between about 825 MPa and about 2124 MPa. In yet a further embodiment, the nanocomposite material has a flexural modulus ranging between about 847 MPa and about 2000 MPa.

It has been advantageously found that embodiment(s) of the nanocomposite material shrink less than a nanofilled material containing the one or more polymeric materials, an (standard) organoclay, and an external compatibilizing material. The shrink is measured about 48 hours after molding, averaging shrink measured in length and width directions. The standard organoclay is a sodium montmorillonite clay treated with dimethyl, dihydrogenated tallow quaternary ammonium chloride.

In an embodiment, the nanocomposite material has a transmission electron microscopy (TEM) mean free path (mfp) ranging between about 0.23 and about 0.64. In a further embodiment, the nanocomposite material has a TEM mfp ranging between about 0.32 and about 0.42.

Nanocomposite material(s) according to embodiments described herein have an aspect ratio ranging between about 100 and about 200; and in an alternate embodiment, an aspect ratio ranging between about 150 and about 160. In a further alternate embodiment, the nanocomposite material(s) have an aspect ratio of about 155.

To further illustrate the nanocomposite materials and modified nanofiller materials, several examples are described herein. It is to be understood that these examples are provided for illustrative purposes and are not to be construed as limiting the scope of the present disclosure.

Experimental

Hydroxyl groups are embedded in the structure of nanoclay sheets, as well as around the edges of the sheets. The embedded hydroxyls are sterically hindered and not available for reaction, but those around the edges are available for reaction with functional groups, non-limitative examples of which include silane groups. The silane groups were reacted with the silicates of the nanoclay sheets. These clays were then incorporated in embodiments of the nanocomposite materials and evaluated.

Non-limitative examples of suitable polymeric materials used in the preparation of embodiment(s) of nanocomposite materials are shown in Table I under the labels “Polypropylenes,” “Propylene Copolymers” and “Elastomers.” Non-limitative embodiment(s) of suitable silane-treated nanofiller materials used in the preparation of embodiment(s) of nanocomposite materials are shown in Table II. Non-limitative examples of suitable compatibilizing materials used for comparative purposes are shown in Table I under the label “Maleated Resins.” Non-limitative examples of suitable optional additives are shown in Table I under the label “Antioxidants/Light Stabilizers.”

TABLE I

| MATERIAL | SUPPLIER | GRADE |
|---|---|---|
| Polypropylenes | Basell USA, Inc.; | Profax 6101, Profax 6301, Profax |
| | Lansing, Michigan | 6323, Profax 6523, Profax PD 702, |
| | | Profax PH020, Profax PH 350 |
| | Dow Chemical; | TF-1802 |
| | Midland, Michigan | |
| | Equistar Chemicals LP; | Petrothene PP 8001-LK, Petrothene |
| | Houston, Texas | PP 8020-AU, Petrothene PP8020-GU |
| | ExxonMobil Chemical; | PP-1074KN, PP1105E1, PP-3546G, |
| | Houston, Texas | PP1044 |
| | Huntsman Polymers LLC; | H0500NS, P4CCN-41 |
| | Marysville, Michigan | |
| Propylene Copolymers | Basell USA, Inc.; | Profax 7101, Profax 7601, Profax |
| | Lansing, Michigan | EL245S, Profax SD-242, Profax SG- |
| | | 702, Profax SV-152, Hifax CA53G |
| | Dow Chemical; | C700-35N, C702-20, 705-44 NA |
| | Midland, Michigan | |
| | Equistar Chemicals LP; | Petrothene PP36KK01, Petrothene |
| | Houston, Texas | PP35FR03, Petrothene PP35FU01, |
| | | Petrothene PP44FY01, Petrothene |
| | | PP44FZ01, Petrothene PP8752HF, |
| | | Petrothene PP8462HR, Petrothene |
| | | PP8775HU |
| | ExxonMobil Chemical; | PP-AX03BE5, PP822XE1, Mytex |
| | Houston, Texas | AN17K-01, PP7032KN, PP7033N, |
| | | PP8023 |
| Elastomers | Basell USA, Inc.; | Adflex KS021P, Adflex KS358P, |
| | Lansing, Michigan | Hifax CA207A, Hifax CA10GC, |
| | | Hifax CA244 |
| | Dupont-Dow Elastomers LLC; | Engage 8100, Engage 8150, Engage |
| | Wilmington, Delaware | 8200, Engage 8440, Engage 8540, |
| | | Engage 8842, Nordel IP NDR3722P, |
| | | Nordel IP NDR4820P, Nordel IP |
| | | NDR3670, Nordel IP NDR4725P, |
| | | Nordel IP NDR4770R |
| | Equistar Chemicals LP; | Petrothene PP8312-KO, Petrothene |
| | Houston, Texas | PP43QW02 |
| | ExxonMobil Chemical; | Exact 0201, Exact 0210, Exact 8201, |
| | Houston, Texas | Exact 8210, Exact 4053, Exact 4041, |
| | | Exact 3035, Vistalon 404, Vistalon |
| | | 707, Vistalon 785 |
| Maleated Resins | Eastman Chemical Co.; | Epolene E-43, Epolene G-3003, |
| | Carpentersville, Illinois | Epolene G-3015, Epolene C-16, |
| | | Epolene C-18, |
| | Crompton Chemicals; | Polybond 1001, Polybond 1002, |
| | Taft, Louisiana | Polybond 1009, Polybond 3000, |
| | | Polybond 3002, Polybond 3009, |
| | | Polybond 3150, Polybond 3200 |
| | ExxonMobil Chemical; | Exxelor PO1015, Exxelor PO1020, |
| | Houston, Texas | Exxelor VA1840 |
| Antioxidants/Light Stabilizers | Ciba Specialty Chemicals; | Irgafos 126, Irgafos 168, Irganox |
| | Tarrytown, New York | 1010, Irganox 1076, Irganox B900, |
| | | Irgastab FS 210, Irgastab FS 301, |
| | | Irgastab FS 811, Irgastab FS 812 |
| | Cytec Industries Inc.; | Cyasorb UV531, Cyasorb UV1164, |
| | Kalamazoo, Michigan | Cyasorb UV3346, Cyasorb THT4611, |
| | | Cyanox 1212, Cyanox 2246 |
| | Great Lakes Polymer Additives; | Alkanox 240, Alkanox 240-3T, |
| | West Lafayette, Indiana | Anox 70, Lowinox CPL |

TABLE II

| PRODUCT NAME | DESCRIPTION |
|---|---|
| Silane organoclay 1 | Sodium Montmorillonite treated |
| | with phenyltriethoxysilane |
| Silane organoclay 2 | Sodium Montmorillonite treated |
| | with n-octadecyltriethoxysilane |
| Silane organoclay 3 | Sodium Montmorillonite treated |
| | with n-octyltriethoxysilane |

The formulations made and tested are shown in Table III under “Formulations 1-10.”

TABLE III

| | Formulations | | | | | | | | | |
|---|---|---|---|---|---|---|---|---|---|---|
| Materials | 1 | 2 | 3 | 4 | 5 | 6 | 7 | 8 | 9 | 10 |
| Polymeric Material- | 100 | 100 | 100 | 100 | 100 | 100 | 100 | 100 | 100 | 100 |
| HIFAX CA53G | | | | | | | | | | |
| Standard Clay | | | 5.0 | 5.0 | | | | | | |
| Silane Organoclay 1 | | | | | 5.0 | 5.0 | | | | |
| Silane Organoclay 2 | | | | | | | 5.0 | 5.0 | | |
| Silane Organoclay 3 | | | | | | | | | 5.0 | 5.0 |
| Compatibilizer (MA-PP) | | 5.0 | | 5.0 | | 5.0 | | 5.0 | | 5.0 |
| Antioxidant | 0.2 | 0.2 | 0.2 | 0.2 | 0.2 | 0.2 | 0.2 | 0.2 | 0.2 | 0.2 |
| Total Parts per Hundred | 100.2 | 105.2 | 105.2 | 110.2 | 105.2 | 110.2 | 105.2 | 110.2 | 105.2 | 110.2 |
| of Resin (PHR) | | | | | | | | | | |

A Midi 2000 extruder and a micro-injection molder system (DMS, Netherlands) were used to process and mold all formulations. The tabletop extruder is a fully intermeshing co-rotating extruder that has a net capacity of 15 cm³. Formulations were extruded at optimum processing conditions of 180° C. and 200 rpm for 2 minutes. Due to its 15 cm³ capacity, it was necessary to run three batches for each formulation so that 7 specimens were available for measurement of the flexural modulus, one specimen for X-ray diffraction, and one specimen for transmission electron microscopy (TEM). Shrink measurements were also measured on the flexural modulus bars.

A nanocomposite material was extruded using silane-treated clay in place of a standard clay, Cloisite 20A (a sodium montmorillonite clay treated with dimethyl, dihydrogenated tallow quaternary ammonium chloride). Cloisite 20A is commercially available from Southern Clay Products, Inc. in Gonzales, Tex. Controls without filler were also formulated for benchmarking.

The coefficient of linear thermal expansion (CLTE) of Formulation 9 is about 17% less than that of Formulation 1. The CLTE of Formulation 9 is about 20% less than that of Formulation 2. The CLTE of Formulation 9 is about 10% less than that of Formulation 3. The CLTE of Formulation 9 is about 3% less than that of Formulation 4. Table IV shows that the silane treated clays without PolyBond (a maleated polypropylene (MA-PP) compatibilizing material commercially available from Crompton Chemicals in Taft, La.) have CLTEs equivalent or less than the polymeric materials alone or with standard clay and/or compatibilizer.

TABLE IV

| Formu- | Average CLTE | |
|---|---|---|
| lation | Points −30 to 100 | Description |
| 1 | 11.7 * 10⁻⁵ | Unfilled TPO (HIFAX CA53G) |
| 2 | 12.3 * 10⁻⁵ | Unfilled TPO + compatibilizer |
| 3 | 10.8 * 10⁻⁵ | TPO + standard clay |
| 4 | 9.77 * 10⁻⁵ | TPO + standard clay + compatibilizer |
| 5 | 10.7 * 10⁻⁵ | TPO + Silane Organoclay 1 |
| 6 | 10.8 * 10⁻⁵ | TPO + Silane Organoclay 1 + compatibilizer |
| 7 | 10.2 * 10⁻⁵ | TPO + Silane Organoclay 2 |
| 8 | 10.3 * 10⁻⁵ | TPO + Silane Organoclay 2 + compatibilizer |
| 9 | 9.74 * 10⁻⁵ | TPO + Silane Organoclay 3 |
| 10 | 9.95 * 10⁻⁵ | TPO + Silane Organoclay 3 + compatibilizer |

The flexural modulus was measured using injection-molded samples from the tabletop injection molder according to the standard ISO test method. Five to seven molded samples for each formulation were measured to determine the variability.

The shrink was measured 48 hours after molding. It was measured in two dimensions (length and width). The formulas are:
((mold length−sample length)/(mold length))×1000
((mold width−sample width)/(mold width))×1000

The units can be either mm/m or mils/inch. The composite shrink was calculated taking the average of the length and width directions.

The flexural moduli and shrink for Formulations 1-10 are shown below in Table V.

TABLE V

| | | FLEX. MOD. | | | | | |
|---|---|---|---|---|---|---|---|
| | FLEX MOD. | (2 mm/min @ | COMPOSITE | INC. FLEX | DEC. | INC. FLEX | DEC. |
| | (2 mm/min @ 23° C.) | 23° C.) | TOOL SHRINK | MOD. | SHRINK | MOD. | SHRINK |
| F. No. | (Kpsi) | (MPa) | (mm/M) | Over #1 | Over #1 | Over #4 | Over #4 |
| 1 | 83 ± 5 | 571 ± 35 | 12.45 | | | | |
| 2 | 89 ± 5 | 613 ± 34 | 12.52 | | | | |
| 3 | 117 ± 6 | 807 ± 43 | 11.71 | | | | |
| 4 | 116 ± 4 | 801 ± 24 | 11.57 | | | | |
| 5 | 125 ± 5 | 862 ± 37 | 11.17 | 50.60% | 10.28% | 7.76% | 3.46% |
| 6 | 127 ± 6 | 877 ± 40 | 11.48 | | | | |
| 7 | 125 ± 3 | 865 ± 18 | 11.32 | 50.60% | 9.08% | 7.76% | 2.16% |
| 8 | 132 ± 4 | 909 ± 25 | 10.89 | | | | |
| 9 | 123 ± 5 | 846 ± 32 | 11.30 | 48.19% | 9.24% | 6.03% | 2.33% |
| 10 | 124 ± 4 | 857 ± 27 | 11.96 | | | | |

The silane treatment of the nanoclay was done in order to react the edge hydroxyl groups found on the clay sheets with the silane. Without being bound to any theory, it is believed that this treatment fortuitously substantially diminishes the polarity of the clay sheets (i.e. shields the polar groups of the nanofiller material) in an effort to make them more compatible with the non-polar hydrocarbon polymeric materials, polymeric matrix, and/or copolymer matrix.

Silane organoclays 1-3 were prepared and supplied by Southern Clay Products, Inc. in Gonzales, Tex. A list of the silanated clays is shown in Table II. NMR analysis confirmed the reaction of the silanes with hydroxyl groups on the clays.

As shown in Tables V and VI, substantially identical compositions prepared using the silane organoclays 1-3 exhibited higher flex moduli without the external compatibilizer than those prepared using a standard nanofiller (Cloisite 20A) and an external compatibilizer.

TABLE VI

| | | | FLEXURAL |
|---|---|---|---|
| FORMU- | | COMPAT- | MODULUS |
| LATION | CLAY | IBILIZER | (MPa) |
| 1 | — | — | 571 ± 35 |
| 2 | — | MA-PP | 613 ± 34 |
| 3 | Standard | — | 807 ± 43 |
| 4 | Standard | MA-PP | 801 ± 24 |
| 5 | Silane Organoclay 1 | — | 862 ± 37 |
| 6 | Silane Organoclay 1 | MA-PP | 877 ± 40 |
| 7 | Silane Organoclay 2 | — | 865 ± 18 |
| 8 | Silane Organoclay 2 | MA-PP | 909 ± 25 |
| 9 | Silane Organoclay 3 | — | 846 ± 32 |
| 10 | Silane Organoclay 3 | MA-PP | 857 ± 27 |

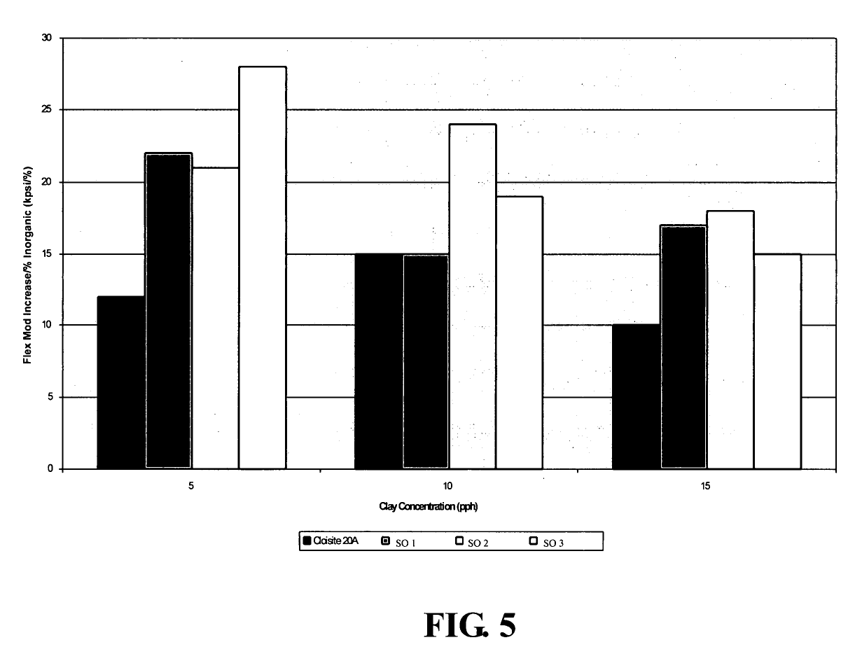

Another method to compare formulations is to determine the increase in flexural modulus as a function of the inorganic content. This effect may be estimated by burning off the organics to determine how much inorganic filler is present. Once the inorganics are determined, the increase in flexural modulus per percent inorganic concentration (PIC) is measured. As seen in FIG. 5, it was evident from the PICs measured that the nanocomposite materials having silane organoclays incorporated therein are substantially as good or better than those nanofilled materials having a standard clay (Cloisite 20A) with the compatibilizer. In FIG. 5, “SO1” stands for Silane Organoclay 1, “SO2” stands for Silane Organoclay 2, and “SO3” stands for Silane Organoclay 3. These silanated organoclays were prepared as described in further detail below.

The above comparisons demonstrate that with the inclusion of the silane-treated clays, there is generally a greater impact on the flexural modulus increase than with the inclusion of standard 20A clay. It was further found that, generally, with increased loadings, the benefits may decrease, that is, the higher loading may diminish the silane organoclay's impact on the flexural modulus per unit of inorganic filler.

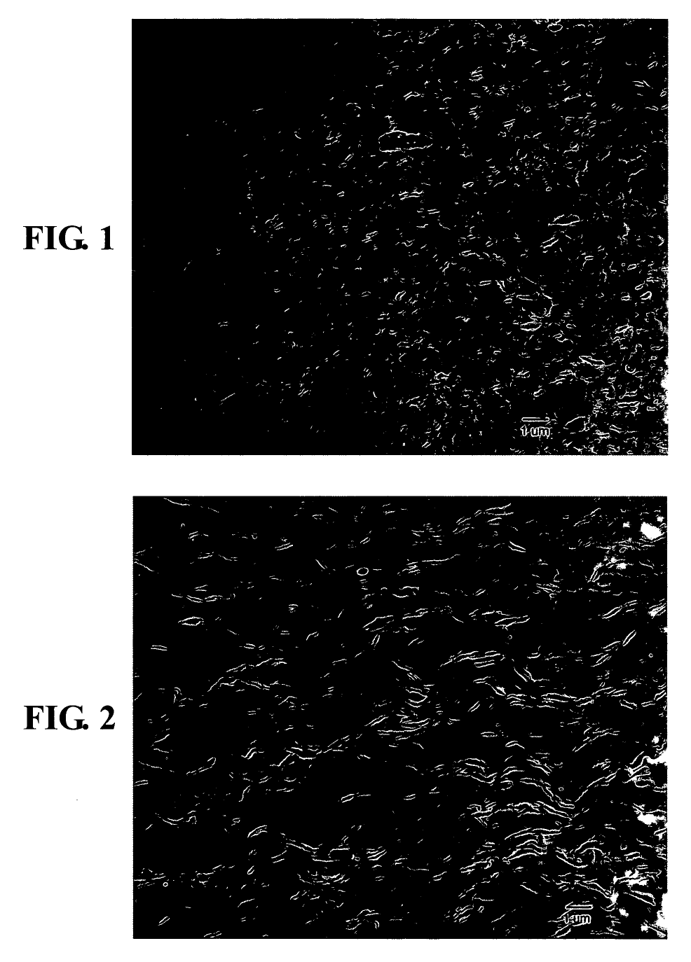

Other formulations described further below, and the results of which are shown in the TEM micrographs of FIGS. 1-4, were made from one or more of the polymeric materials listed in Table I, one or more of the silane organoclays listed in Table II, and without compatibilizer. TEM micrographs were obtained on these formulations using a Philips 430t microscope operating at 300 kV and using thin sections prepared by cyro-microtome using a Reichert Jung ultra-microtome at a temperature of −90° C.

The Mean Free Path (mfp) is the average distance between particles. This measurement between the clay particles imaged in the TEM micrographs gives a semi-quantitative estimate of the amount of exfoliation. A straight line perpendicular to the direction of the clay particles is placed on the TEM micrograph. The particles intersecting the line are then counted. This is repeated for several parallel lines. The total distance measured is then divided by the total number of counted particles to give an average distance between the particles. A smaller number means that there is less distance between the particles; which thus means more exfoliation and better dispersion of the clay.

The aspect ratio, which is the length divided by thickness (L/T) of a clay particle, was calculated for several particles and then averaged. The mean free paths (mfp) for the other formulations are consistently low, ranging from about 0.23 to about 0.64, which indicates that there is good exfoliation and dispersion of the clay. Previously, the mfp's for non silane-treated nanocomposite materials had been measured as high as about 1.8. Although these are not generally absolute quantitative values, the mfp is an indication of the degree of exfoliation.

FIG. 1 is a micrograph representing Hifax DX277 (Basell USA, Inc.) with Cloisite® 20A. The mfp is 0.42, and the average aspect ratio is 30. This is representative of the better exfoliated previous nanocomposites. FIG. 2 displays a micrograph of a High Modulus TPO Resin containing SO1, phenyltriethoxysilane. The mfp for this embodiment is 0.42. Rather than finding a random orientation in the exfoliated clay as in the non-silane clay formulations, the clay sheets are lined up substantially end-to-end. Although the sheet length is a combination of shorter clay particles, their alignment results in a much higher-effective aspect ratio of 155. It is believed that this higher effective aspect ratio contributes to higher flexural modulus.

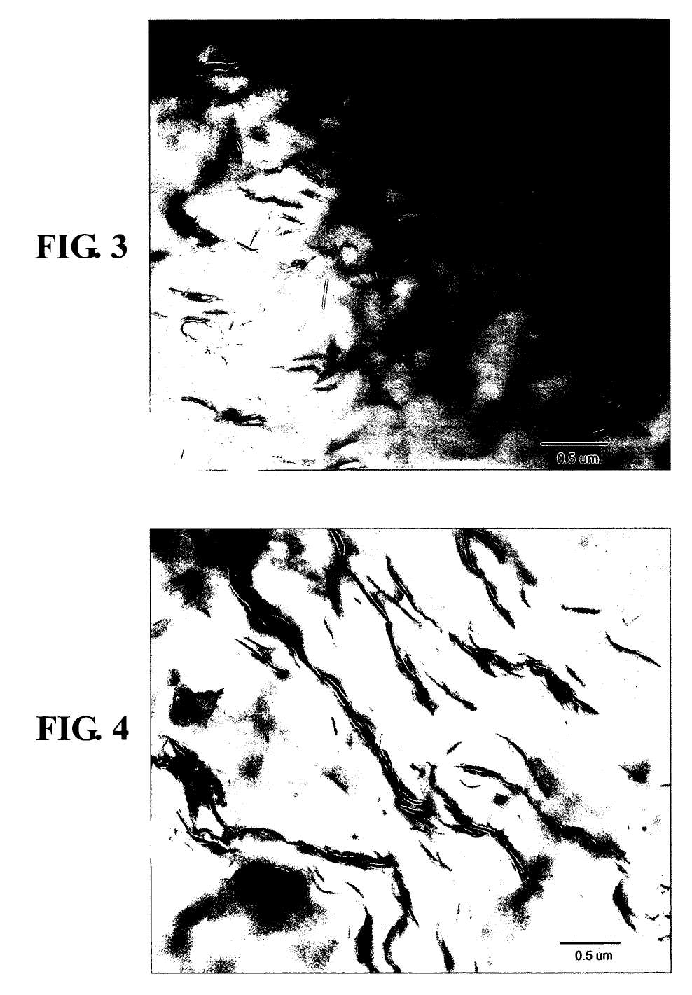

This is even more apparent in FIG. 4, which is a TEM at higher magnification. FIG. 4 is a micrograph of the same formulation shown in FIG. 2 but containing a different silanated clay, n-octyltriethoxysilane (SO3). Its mfp is 0.42 and aspect ratio is 155. By comparison, FIG. 3 (higher magnification of DX277 with Cloisite® 20A in FIG. 1) shows the clay sheets which are much shorter and have smaller aspect ratios of ˜40. See Table VII.

The mean free paths (mfp) for these silane-clay formulations are consistently low, ranging from about 0.23 to about 0.64, which indicates that there is good exfoliation and dispersion of the clay platelets within the polymer matrix. Previous mfp measurements for nanocomposites made from non-silanated clay compositions have been as high as about 1.8. Although these are not generally absolute quantitative values, the mfp is a rough indication of the degree of exfoliation.

TABLE VII
TEM Data, Mean Free Path and Aspect Ratio

| FIGURE | MEAN FREE PATH | ASPECT RATIO |
|---|---|---|
| 1 | 0.42 | ˜30 |
| 2 | 0.42 | ˜155 |
| 3 | 0.42 | ˜40 |
| 4 | 0.32 | ˜155 |

The nanocomposites made with modified nanofillers (non-limitative examples of which include silane-treated clays) according to embodiments described herein had equal or increased flexural moduli without the need of external compatibilizers. In some instances, the addition of an external compatibilizer actually reduced the flexural modulus in these novel formulations.

Some experiments were also run on formulation(s) according to embodiment(s) as disclosed herein to determine the effect of scale up. It was advantageously found that scale up formulations also exhibited generally equivalent fortuitous physical properties, such as flexural modulus.

The nanocomposite formulations according to embodiments described herein have many advantages. One non-limitative advantage is that the embodiments described herein may be more cost effective than current formulations prepared using the external compatibilizer, while providing essentially the same or better physical properties. In addition to the physical property advantages, it has been discovered that using these nanofillers without an external compatibilizer generally prevents undesirable agglomeration of the filler materials during processing, thereby further substantially improving the surface of the molded nanocomposite materials.

Nanocomposites in general are lighter weight, higher performance systems when compared to conventionally filled thermoplastics. As stated in more detail above, external compatibilizer was previously required to produce nanocomposites using clay nanofillers. It is believed that shielding of the nanofiller polar groups enabled production of the novel nanocomposites without using the external compatibilizer. This results in nanocomposite materials with high aspect ratios and good dispersion, thus leading to an increase in flexural modulus and improved surface appearance in parts molded therefrom at a potentially significant cost reduction.

Non-limitative methods of making suitable embodiment(s) of the modified nanofiller material as disclosed herein are discussed further hereinbelow.

Dispersible organophilic clays and hydrophilic clays may be made by modifying clays with a silicon compound. Treatment of clays with a silicon compound may enhance dispersibility of the clays into polymerizable organic systems (e.g., monomers and/or polymers). In some embodiments, a silanated clay composition may be treated with an onium compound to form a silanated organoclay composition. The silanated clays and silanated organoclays may enhance physical properties and/or mechanical properties of polymerizable monomer and/or polymer systems.

As used herein, the term “clay” refers to any expanding clay mineral with hydroxyl functionality, expanding clay-like mineral with hydroxyl functionality, and/or combinations thereof. Expanding clays include, but are not limited to, smectites, smectite-like minerals, smectite-like cationic minerals, and combinations thereof. As used herein, the term “smectite” or “smectite-like clay” refers to a material with an expandable crystal lattice. Smectite clays include, but are not limited to, montmorillonite, beidellite, nontronite, illite, saponite, hectorite, sauconite, stevensite, sepiolite and combinations thereof. Smectite-like clays include, but are not limited to vermiculite, mica, and synthetically prepared smectite-like minerals.

Montmorillonite may be represented by the following chemical formula, (Si₈₋ₓAlₓ)(Al_{4-y}(Ti, Fe, Mg)_{y}O₂₀(OH)₄R⁺_{x+y}, where 0≦x≦0.4; 0.55≦y≦1.10; and R represents Na⁺, Li⁺, NH₄⁺ and/or combinations thereof.

Hectorite may be represented by a general chemical formula of: (Mg₆₋ₓLiₓ)Si₈O₂₀(OH, F)₂Rₓ⁺, where 0.57≦x≦1.15; and R represents Na⁺, Li⁺, NH₄⁺ and/or combinations thereof.

Saponite may be represented by a general chemical formula of: (Si₈₋ₓAlₓ)(Mg, Fe)₆O₂₀(OH)₄Rₓ⁺, where 0.58≦×≦1.84; and R represents Na⁺, Li⁺, NH₄⁺ and/or combinations thereof.

Stevensite may be represented by the general chemical formula of: [Mg₆₋ₓSi₈O₂₀(OH)₄]R⁺₂ₓ, where 0.28≦x≦0.57; and R represents Na⁺, Li⁺, NH₄⁺ and/or combinations thereof.

Beidellite may be represented by the general chemical formula of: [Al₄(Si₈₋ₓAlₓ)O₂₀(OH)₄]R⁺ₓ, where 0.55≦x≦1.10; and R represents Na⁺, Li⁺, NH₄⁺ and/or combinations thereof.

A clay may include one or more individual platelets (e.g., layers) that may be intercalated. Upon intercalation, an interlayer spacing between the platelets may increase between the individual platelets. As used herein, “interlayer spacing” refers to a distance between internal faces of adjacent clay platelets as the clay platelets are assembled in a layered clay. Intercalation may be performed using ion exchange techniques. As used herein, the term “ion exchange” refers to the interchange of ions from one substance to another. In one embodiment, an ion exchange substance includes one or more cationic organic materials (e.g., ammonium compounds).

A clay that undergoes intercalation may exhibit a cation exchange capacity (CEC) of between about 50 to about 200 milliequivalents per 100 grams of the clay. Cation exchange capacity may be determined using generally known methods (e.g., ammonium acetate methods such as U.S. Environmental Protection Agency Method 9080).

In certain embodiments, a clay may be converted to a sodium form prior to being intercalated. Conversion of the clay to the sodium form may be performed by preparing an aqueous clay slurry. The aqueous clay slurry may be contacted with a sodium exchange resin using general techniques (e.g., fluid bed reactors, ion exchange columns). As the aqueous clay contacts the sodium exchange resin, sodium cations are exchanged for cations in the clay. In other embodiments, a clay may be mixed with water and a soluble sodium compound to perform an ion exchange. The resulting ion exchanged mixture may be sheared using generally known processes (e.g., a Manton-Gaulin homogenizer, a colloid mill). Examples of soluble sodium salts include, but are not limited to, sodium carbonate, sodium hydroxide, sodium sulfate and combinations thereof.

In an embodiment, a clay may be mixed with water to produce a dilute aqueous clay slurry. An amount of clay in the aqueous clay slurry may be from about 0.5% by weight to about 10% by weight, based on the total weight of the slurry. In certain embodiments, an amount of clay in the aqueous clay slurry may be from about 1% by weight to about 6% by weight, based on the total weight of the slurry. The clay may be purified to remove non-clay components using generally known techniques (e.g., centrifugation). The aqueous clay slurry may be subjected to high-speed fluid shearing in a suitable mill (e.g., Manton-Gaulin homogenizer). High-speed fluid shearing of the aqueous clay slurry may be performed by passing the aqueous clay slurry through a narrow gap at high velocities. A high-pressure differential may be maintained across the narrow gap (e.g., 8000 psi). Shearing of clay slurries is described in U.S. Pat. No. 5,160,454 to Knudson Jr. et al., which is incorporated by reference as if fully set forth herein.

The aqueous clay slurry may be heated to a temperature at or below 100° C. In certain embodiments, an aqueous clay slurry may be heated to a temperature ranging from about 50° C. to about 75° C. In other embodiments, an aqueous clay slurry may be heated to a temperature ranging from about 25° C. to about 50° C. In some embodiments, an aqueous clay slurry may be heated to a temperature ranging from about 60° C. to about 70° C.

A pH of the aqueous clay slurry may be adjusted with one or more acids to produce a clay slurry with a pH value of less than about 7. In certain embodiments, a pH of an aqueous clay slurry may be adjusted to a pH value between about 7 and about 3 with an acid and/or a combination of acids. In other embodiments, a pH of an aqueous clay slurry may be adjusted to a pH value between about 5 and about 3 with an acid and/or a combination of acids. In some embodiments, the pH of an aqueous clay slurry may not be adjusted. A pH of the aqueous clay slurry may be adjusted before heating the aqueous clay slurry. In embodiments that use heated aqueous clay slurries, a pH of the aqueous clay slurry may be adjusted with one or more acids to produce a pH value of less than about 7.

An acid used to adjust the pH of the aqueous clay slurry, may be an inorganic acid or an organic acid. Inorganic acids include, but are not limited to, hydrochloric acid, hydrobromic acid, hydroiodic acid, sulfuric acid, selenic acid, sulfamic acids and/or combinations thereof. Organic acids may be one or more carboxylic acids or sulfonic acids that may adjust the pH of an aqueous solution to a value of less than about 7.

The acid treated aqueous clay slurry may be contacted with a silicon compound to form a silanated clay composition. The silicon compound may include, but is not limited to, an organosilane, a polysiloxane, a sulfurized organosilane and/or combinations thereof. An amount of silicon compound may range from about 0.01% by weight to about 50% by weight based on a dry weight of the clay. In certain embodiments, an amount of silicon compound may range from about 0.01% by weight to about 10% by weight based on a dry weight of clay. In other embodiments, an amount of silicon compound may range from about 2% by weight to about 4% by weight based on a dry weight of clay.

An organosilane contains at least one group capable of undergoing hydrolysis for reaction with hydroxyl materials and may be represented by a general chemical formula of: Rₙ—Si—X₍₄₋ₙ). X represents an alkoxy group, an aryloxy group, an amino group, hydrogen or a halogen, and n represents an integer from 1 to 3. R represents an appropriate organic substituent that renders the organosilane at least partially compatible with a resin system and/or with a monomer and/or polymer system of choice. In an embodiment, R represents an alkyl group, an aryl group, an alkylaryl group, a vinyl group, an allyl group, an alkylamino group, an arylamino group, or organic moieties that may contain ketone, ester, ether, organosulfur or carboxyl groups. R may have a carbon atom number ranging from 1 to 30. Non-limiting examples of R may include methyl, ethyl, phenyl, n-octyl, n-octadecyl, 2-ethylhexyl, n-dodecyl, and/or the like, and/or mixtures thereof. Organosilane compounds may include, but are not limited to, n-octyltriethoxysilane, n-propyltriethoxysilane, phenylsilane, ethyltriethoxysilane, ethyltrimethoxysilane, methyltrimethoxysilane, methyltriethoxysilane, vinyltrimethoxysilane, vinyltriethoxysilane, 3-aminopropyltriethoxy silane, N-(2-aminoethyl)-3-aminopropyltrimethoxysilane, N-(2-aminoethyl)-3-aminopropyltriethoxysilane, aminopropyltriethoxysilane and/or derivatives or combinations thereof.

A polysiloxane may be represented by a general chemical formula of: 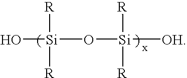
where R represents an alkyl group, an aryl group, an alkylaryl group, a vinyl group, an allyl group, an alkylamino group, an arylamino group or organic groups that include ketone, ester, ether, organosulfur or carboxyl groups. R may have a carbon atom number ranging from 1 to 30. x represents an integer such that an average molecular weight of the compound may be from about 1,000 to about 75,000. Polysiloxane compounds may include, but are not limited to, polydimethylcyclosiloxane, polymethylhydrogensiloxane, polydimethylsiloxane, polyvinylsiloxane and/or polyvinylmethylsiloxane.

A sulfurized organosilane may be represented by a general chemical formula of: R′SₘCH₂CH₂CH₂Si(OR)₃. R′ represents hydrogen or an organosilane group represented by the chemical structure (R″O)₃SiCH₂CH₂CH₂, and m represents an integer from 1 to 4. R and R″ represent an organic group containing from 1 to 8 carbon atoms. A mercapto silicon compound may be represented by the chemical formula, HSCH₂CH₂CH₂Si(OR)₃. A tetrasulfane silicon compound may be represented by the chemical formula,
(RO)₃SiCH₂CH₂CH₂SSSSCH₂CH₂CH₂Si(OR)₃.

The aqueous clay slurry may be heated to a temperature at or below 100° C. and the silicon compound contacted (e.g., mixed) with the slurry. The resulting silicon compound treated aqueous clay slurry may remain at or below 100° C. for about 1 hour to form a silanated clay composition. In certain embodiments, a slurry temperature may range from about 60° C. to about 75° C. In some embodiments, a silicon compound may be contacted with an acid treated clay slurry to form an aqueous silicon compound/clay slurry before heat is applied to the mixture.

In certain embodiments, a silicon compound may be contacted with water to form an aqueous silicon dispersion prior to contacting the silicon compound with the clay. In some embodiments, a silicon compound may not disperse in water as desired. To facilitate dispersion of the silicon compound in water, a surfactant may be contacted with the aqueous silicon dispersion to form a silicon compound/surfactant emulsion.

Surfactants may include, but are not limited to, anionic surfactants (e.g., dodecylbenzene sulfonic acid), non-ionic surfactants (e.g., polyoxyethylene(23)lauryl ether, (Me₃SiO)₂MeSi(CH₂)₃(OCH₂CH₂)OMe), ethoxylated polydimethylsiloxane, nonylphenol ethoxylate, nonyl phenol ethoxylate (4 moles EO)) and cationic surfactants (e.g., N-alkyltrimethyl ammonium chloride). In certain embodiments, a surfactant may be an ethoxylated polydimethylsiloxane having a molecular weight of less than about 3000 and greater than about 50% ethylene oxide moieties.

An amount of surfactant contacted with the aqueous silicon dispersion may be enough to produce a stable silicon compound/surfactant emulsion (e.g., milky emulsion) which can remain as an emulsion for up to about 8 hours. An amount of surfactant may range between about 0.05% by weight to about 5% by weight, based on a weight of dry clay. In certain embodiments, an amount of surfactant may be from about 0.1% by weight to about 1.0% by weight, based on a weight of dry clay. In other embodiments, an amount of surfactant may be from about 0.2% by weight to about 0.4% by weight, based on a weight of dry clay. For example, about 0.3 wt. %, based on dry weight of a clay, of an ethoxylated polydimethylsiloxane surfactant with greater than 50% ethylene oxide (EO) and a molecular weight of less than 3000 may be combined with about 3 wt. % of a silicon compound, based on a dry weight of clay and about 90% to about 98% water to form an aqueous silicon compound/polydimethylsiloxane surfactant emulsion. In some embodiments, a surfactant may be contacted with the water before addition of the silicon compound.

In certain embodiments, a surfactant may be dispersed in a silicon compound to form a silicon compound/surfactant mixture. In some embodiments, a silicon compound/surfactant mixture may be contacted with water to form a silicon compound/surfactant emulsion. An amount of surfactant may range between about 0.05% by weight to about 5% by weight, based on a weight of dry clay. In certain embodiments, an amount of surfactant may be from about 0.1% by weight to about 1.0% by weight, based on a weight of dry clay. In other embodiments, an amount of surfactant may be from about 0.2% by weight to about 0.4% by weight, based on a weight of dry clay. The silicon compound/surfactant dispersion may be contacted (e.g., mixed) with a heated acid treated clay slurry to form a silanated clay composition.

The silicon compound/surfactant emulsion may be contacted (e.g., mixed) with an acid treated clay slurry at a temperature at or below 100° C. The resulting aqueous silicon compound/surfactant treated clay slurry may remain at or below 100° C. for about 1 hour to form a silanated clay composition. In certain embodiments, a silicon compound/surfactant emulsion may be contacted with an acid treated clay slurry at a temperature ranging from about 50° C. to about 75° C. to form a silanated clay composition. In other embodiments, a silicon compound/surfactant emulsion may be contacted with an acid treated clay slurry at a temperature ranging from about 25° C. to about 50° C. In some embodiments, a silicon compound/surfactant emulsion may be contacted with an acid treated clay slurry at a temperature ranging from about 60° C. to about 70° C.

In certain embodiments, a surfactant may be added to an acid treated clay slurry at a temperature of less than 100° C. An amount of surfactant may range between about 0.05% by weight to about 5% by weight, based on a weight of dry clay. In certain embodiments, an amount of surfactant may be from about 0.1% by weight to about 1.0% by weight, based on a weight of dry clay. In other embodiments, an amount of surfactant may be from about 0.2% by weight to about 0.4% by weight, based on a weight of dry clay. A silicon compound may be added to the surfactant/clay slurry mixture. An amount of silicon compound added may range from about 0.01% by weight to about 50% by weight based on a dry weight of the clay. In certain embodiments, an amount of silicon compound may range from about 0.01% by weight to about 10% by weight based on a dry weight of clay. In other embodiments, an amount of silicon compound may range from about 2% by weight to about 4% by weight based on a dry weight of clay. The resulting aqueous silicon compound treated clay/surfactant slurry may remain at or below 100° C. for about 1 hour to form a silanated clay composition.

In some embodiments, the silicon compound may be contacted with a surfactant treated acid treated clay slurry at a temperature ranging from about 50° C. to about 75° C. In other embodiments, a silicon compound may be contacted with a surfactant/acid treated clay slurry at a temperature ranging from about 25° C. to about 50° C. In some embodiments, a silicon compound may be contacted with a surfactant/acid treated clay slurry at a temperature ranging from about 60° C. to about 70° C.

A silanated clay composition may be subjected to high shearing in a suitable mill (e.g., a homogenizing mill). The shearing action may be produced in a Manton-Gaulin device (“Manton-Gaulin” or “Gaulin homogenizer”). U.S. Pat. No. 4,623,398 to Goodman, et al. and U.S. Pat. No. 4,743,305 to Doidge, et al., both of which are incorporated by reference as if fully set forth herein, describe a Manton-Gaulin device. In a homogenizing mill, passing the silanated clay composition through a narrow gap in the Manton-Gaulin mill at high velocities may produce a high-speed fluid shear of the organoclay composition. A high-pressure differential may be maintained across the gap. The pressure differential across the gap may be less than about 8,000 psig. The silanated clay composition may be passed through a Manton-Gaulin mill one or more times.

In an embodiment, a clay may be subjected to a high shear treatment prior to addition of a silicon compound. U.S. Pat. No. 4,664,842 to Knudson Jr. et al., and U.S. Pat. No. 5,110,501 to Knudson Jr. et al., both of which are incorporated by reference as if fully set forth herein, describe a high shear treatment of a clay prior to addition of a quaternary ammonium compound.

Different arrangements of the milling equipment components may be utilized to provide high shearing of a clay and/or silanated clay. Rotor and stator arrangements are described in U.S. Pat. No. 5,160,454 to Knudson, Jr., et al., which is incorporated by reference as if fully set forth herein. The use of high shear may disperse the silanated clay into individual platelets such that dispersion may be enhanced during addition to an organic matrix. Following a high shear step, a silanated clay may be subjected to other processing treatments such as, but not limited to, filtering, milling and/or drying. The silanated clay composition may be milled to an average particle size of at least 200 micrometers (μm). In certain embodiments, a silanated clay composition may be milled to average particle size of at least 100 μm. In some embodiments, a silanated clay composition may be milled to average particle size of at least 60 μm. In other embodiments, a silanated clay composition may be milled to an average particle size of at least 8 μm.

In some embodiments, an aqueous silanated clay slurry may be dried in an oven (e.g. blower oven) to remove excess water to form a dried silanated clay composition. In some embodiments, a wet silanated clay composition may be filtered, then dried, to remove excess water and unreacted components. The oven temperature during drying may range from about 50° C. to about 120° C. The dry silanated clay composition may be milled using generally known techniques to a desired particle size.

In certain embodiments, a silanated clay slurry may be subjected to treatment with an onium compound or a combination of onium compounds to form a silanated organoclay composition at a temperature of at or below 100° C. In some embodiments, a temperature treatment may range from about 25° C. to about 80° C. In other embodiments, a temperature treatment may range from about 50° C. to about 75° C.

“Onium compound” as used herein, refers to a charged organic compound. In some embodiments, an onium compound includes a Group VA element or a Group VIA element of the Periodic Table capable of forming one or more positive charges. Group VA and Group VIA elements include, but are not limited to, nitrogen, phosphorous or sulfur.

The organic portion of the onium compound may include, but is not limited to, alkyl groups, aromatic groups, alkylaryl groups, cyclic groups and/or cyclic heteroatom groups. Alkyl groups may be derived from, but are not limited to, petrochemical processes (e.g., α-olefins), animal oils, animal fats, natural oils, vegetable oils or combinations thereof. Examples of oils include tallow oil, soybean oil, coconut oil, castor oil, corn oil, cottonseed oil and/or palm oil. Examples of onium compounds may include trimethyl ammonium, trimethyl phosphonium, dimethyl sulfonium or tetraethyl ammonium.

Examples of aromatic groups may include, a benzyl group, a substituted benzyl group, a benzyl-type material and/or a benzylic-type material derived from a benzyl halide, a benzhydryl halide, a trityl halide, or an α-halo-α-phenylalkane. An alkane portion of the α-halo-α-phenylalkane may have an average carbon atom number ranging from 1 to 30. Examples of α-halo-α-phenylalkanes include, 1-halo-1-phenyloctadecane, substituted benzyl moieties, (e.g., derived from ortho-, meta- and para-chlorobenzyl halides), para-methoxybenzyl halides, ortho-nitrilobenzyl halide, meta-nitrilobenzyl halide, para-nitrilobenzyl halide ortho-alkylbenzyl halides, meta-alkylbenzyl halides, para-alkylbenzyl halides and/or fused ring benzyl-type moieties. An average carbon atom number of the alkyl portion of the alkylbenzyl halides may range from 1 to 30. A fused ring benzyl-type moiety may be derived from 2-halomethylnaphthalene, 9-halomethylanthracene and/or 9-halomethylphenanthrene. The halo portion of the fused ring precursor may include, but is not limited to, chloro, bromo and/or any other group that may serve as a leaving group in a nucleophilic attack of the benzyl-type moiety such that the nucleophile replaces the leaving group on the benzyl-type moiety.

Examples of other aromatic groups may include, a phenyl group, an alkyl phenyl group, a N-alkyl aniline group, a N,N-dialkyl aniline group, an ortho-nitrophenyl group, a meta-nitrophenyl group, and para-nitrophenyl group. Examples of alkyl phenyl groups may include ortho-alkyl phenyl group, a meta-alkyl phenyl group and a para-alkyl phenyl group. An average carbon atom number for the alkyl portion of the alkyl phenyl group may range from 1 to 30. Additional examples of aromatic groups may include 2-halophenyl, 3-halophenyl or 4-halophenyl. The halo group may include, but is not limited to, chloro, bromo or iodo. Further examples of aromatic groups may include 2-carboxyphenyl, 3-carboxyphenyl and 4-carboxyphenyl and/or esters thereof. The alcohol portion of the ester may be derived from an alkyl alcohol. The alkyl portion of the alkyl alcohol may have an average carbon atom number ranging from 1 to 30. The alkyl portion of the alkyl alcohol may include, but is not limited to, phenol, benzyl alcohol moieties; and/or fused ring aryl moieties (e.g., naphthalene, anthracene, and phenanthrene).

Examples of cyclic heteroatom groups may include pyrrole, imidazole, thiazole, oxazole, pyridine, pyrimidine, quinoline, isoquinoline, indole, purine, benzimidazole, benzothiazole, benzoxazole, pyrazine, quinoxaline, quinazoline, acridine, phenazine, imidazopyridine and/or dipyridyl.

In an embodiment, multi-charged onium ions may be represented by a general chemical formula of: 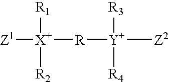
X and Y represent a nitrogen atom, a sulfur atom, a phosphorous atom, an oxygen atom or combinations thereof. R represents a straight or branched organic group having 2 to 24 carbon atoms. R may include, but is not limited to, substituted or unsubstituted alkyl, alkylene, cycloalkyl, cycloalkylene, benzyl, substituted benzyl, or alkylaryl groups. Alkylenes may include, but are not limited to, methylene, ethylene, octylene, nonylene, tert-butylene, neopentylene, isopropylene, sec-butylene, dodecylene. Examples of alkenylenes include 1-propenylene, 1-butenylene, 1-pentenylene, 1-hexenylene, 1-heptenylene, 1-octenylene; Examples of cycloalkenylenes include cyclohexenylene or cyclopentenylene. R¹, R², R³ and R⁴ represent hydrogen, straight or branched organic groups having 1 to 22 carbon atoms or combinations thereof. Z¹ and Z² represent nonexistent, hydrogen, straight or branched organic groups having 1 to 22 carbon atoms, one or more positively charged atoms, or combinations thereof. Examples of Z¹ and Z² include H; tallow; cycloalkenyl; cycloalkyl; aryl; alkylaryl, either unsubstituted or substituted or substituted with amino, alkylamino, dialkylamino, nitro, azido, alkenyl, alkoxy, cycloalkyl, cycloalkenyl, alkanoyl, alkylthio, alkyl, aryloxy, arylalkylamino, alkylamino, arylamino, dialkylamino, diarylamino, aryl, alkylsufinyl, aryloxy, alkylsulfinyl, alkylsulfonyl, arylthio, arylsulfinyl, alkoxycarbonyl, arylsulfonyl, or alkylsilane.

Tallow diamine may be represented by the chemical formula:
RN⁺H₂CH₂CH₂CH₂N⁺H₃

where R=tallow.

Tallow alkylpentamethyl propylenediammonium compound may be represented by a general chemical formula of:

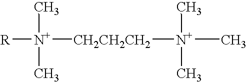

where R=tallow.

Tris(2-hydroxyethyl)-N-tallowalkyl-1,3-diaminopropane may be represented by the chemical formula:

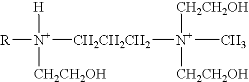

where R=tallow.

Other examples of multi-charged onium compounds include tallow triamine and tallow tetramine. Multi-charged onium ions are described in U.S. Pat. No. 6,262,162 to Lan et al., which is incorporated by reference as if fully set forth herein. The anion associated with the onium compound may be a halogen or a polyatomic anion (e.g., methyl sulfate anion).

In an embodiment, a quaternary ammonium compound may be represented by a general chemical formula of: 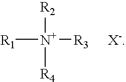
where each of R₁, R₂, R₃ and R₄ represent an alkyl group, an aryl group, an arylalkyl group or combinations thereof. X represents an anion. Alkyl groups may include, but are not limited to, a saturated straight chain alkyl group, a saturated branched-chain alkyl group, an unsaturated branched-chain alkyl group, an unsaturated straight chain alkyl group, or combinations thereof. Alkyl groups may have an average carbon atom number ranging from 1 to 30. Aryl groups may have an average carbon atom number ranging from 7 to 22. Arylalkyl groups may have an average carbon atom number ranging from 7 to 22. The anion may include, but is not limited to, chloride, bromide, iodide, nitrite, hydroxide, nitrate, sulfate, methyl sulfate, halogenated methyl compounds, or C₁ to C₁₈ carboxylate compounds, acetate, phosphate or mixtures thereof. Alkyl quaternary ammonium salts may include, but are not limited to, dimethyl di(hydrogenated tallow) ammonium chloride, methyl benzyl di(hydrogenated tallow) ammonium chloride, dimethyl benzyl hydrogenated tallow ammonium chloride, bis-hydroxyethyl methyl tallow ammonium chloride, dimethyl hydrogenated tallow-2-ethylhexyl ammonium methyl sulfate, methyl bis-2-hydroxyethyl stearyl ammonium chloride, dimethyl dibehenyl ammonium chloride and methyl tris(hydrogenated tallow) ammonium chloride.

Dimethyl di(hydrogenated tallow) ammonium chloride (2M2HT) may be represented by the chemical formula: 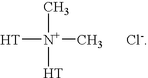
where HT represents hydrogenated tallow.

Methyl bis-2-hydroxyethyl stearyl ammonium chloride (M₂HES) may be represented by the chemical formula:

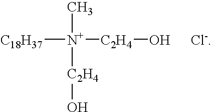

Dimethyl dibehenyl ammonium chloride may be represented by the chemical formula:

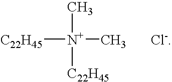

Methyl tris(hydrogenated tallow alkyl) chloride may be represented by the chemical formula: 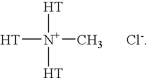
where HT represents hydrogenated tallow.

An amount of onium compound or an amount of a combination of onium compounds required to treat a silanated clay composition may be determined from the characteristics of the silanated clay composition to be produced. As used herein, the term “treatment of a silanated clay composition with an onium compound” generally refers to treating the silanated clay composition with one or more onium compounds. An amount of onium compound for treating a silanated clay composition may range from about 0.5 times to about 2 times the cation exchange capacity of clay based on a weight of the dry clay before any type of treatment. For example, the onium compound may be incorporated in a sufficient quantity to substantially satisfy the cation exchange capacity of a clay and the cationic activity of the onium compound. In some embodiments, an amount of onium compound used to treat a silanated clay composition may be greater than the sum of a cation exchange capacity of the clay and a cationic activity of the onium compound.

In an embodiment, a silanated organoclay may be subjected to high shearing in a suitable mill (e.g., Manton-Gaulin mill). In the mill, passing the silanated organoclay composition through a narrow gap at high velocities may produce a high-speed fluid shear of the silanated organoclay composition. A high-pressure differential may be maintained across the gap. The pressure differential across the gap may be less than about 8,000 psig. The silanated organoclay composition may be passed through the mill one or more times. Different arrangements of the milling equipment components may be utilized to provide high shearing of the organoclay. The use of high shear may disperse the silanated organoclay composition into individual platelets such that dispersion of the silanated organoclay composition may be enhanced during addition of the composition to an organic matrix. Following a high shear step, a silanated organoclay composition may be subjected to other processing treatments including, but not limited to, filtering, milling and/or drying.

In an embodiment, a clay may be subjected to treatment by an onium compound or a combination of onium compounds to form an organoclay. In certain embodiments, a clay slurry may be subjected to treatment by an onium compound or a combination of onium compounds to form a silanated organoclay composition at a temperature of at less than 100° C. In some embodiments, a temperature treatment may range from about 25° C. to about 80° C. In other embodiments, a temperature of treatment may range from about 50° C. to about 75° C.

An amount of onium compound or an amount of a combination of onium compounds required to treat a clay composition may be determined from the characteristics of the clay composition to be produced. As used herein, the term “treatment of a clay composition with an onium compound” generally refers to treating the clay composition with one or more onium compounds. An amount of onium compound required to treat a clay composition may range from about 0.5 times to about 2 times the cation exchange capacity of clay based on a weight of the dry clay before any type of treatment. For example, the onium compound may be incorporated in a sufficient quantity to substantially satisfy the cation exchange capacity of a clay and the cationic activity of the onium compound. In some embodiments, an amount of onium compound used to treat a clay composition may be greater than the sum of a cation exchange capacity of the clay and a cationic activity of the onium compound.

In certain embodiments, an organoclay composition may be contacted with a silicon compound to produce a silanated organoclay composition. An aqueous organoclay slurry may be prepared by combining an amount ranging from about 0.5 wt % to about 10 wt % of the organoclay, based on the total weight of the slurry, with water. In some embodiments, an amount of organoclay combined with water may range from about 1 wt. % to about 6 wt. %, based on the total weight of the slurry. The aqueous organoclay slurry may be heated to a temperature of less than 100° C. In some embodiments, an aqueous organoclay slurry may be heated to a temperature ranging from about 60° C. to about 70° C. In other embodiments, an aqueous clay slurry may be heated to a temperature ranging from about 25° C. to about 50° C.

A pH of the organoclay slurry may be adjusted to an acid pH value using one or more acids. A pH of the organoclay slurry may be adjusted to a pH value of less than about 7. In some embodiments, a pH of the organoclay slurry may be adjusted to a pH value between about 3 and about 5 with an acid. In some embodiments, the pH of an aqueous organoclay slurry may not be adjusted. Acids may include an inorganic acid or an organic acid.

The aqueous organoclay slurry may be contacted with a silicon compound to form a silanated organoclay composition. The silicon compound may include, but is not limited to, an organosilane, a polysiloxane, a sulfurized organosilane or combinations thereof. An amount of silicon compound may range from about 0.5% by weight to about 50% by weight based on a dry weight of the organoclay. In certain embodiments, an amount of silicon compound may range from about 2% by weight to about 4% by weight based on a dry weight of an organoclay composition. In other embodiments, an amount of silicon compound may range from about 1% by weight to about 10% by weight based on a dry weight of an organoclay composition.

In certain embodiments, a silicon compound may be contacted with water to form an aqueous silicon dispersion. The aqueous silicon dispersion may be contacted with an aqueous organoclay slurry and heated as previously described to form a silanated organoclay composition. In some embodiments, a silicon compound may not disperse as desired in water. To facilitate dispersion of the silicon compound in water, a surfactant may be contacted with the aqueous silicon dispersion to form an aqueous silicon emulsion. In some embodiments, a surfactant may be contacted with the water before addition of the silicon compound. In other embodiments, a surfactant may be dispersed in a silicon compound to form a silicon compound/surfactant dispersion. The silicon compound/surfactant dispersion may be contacted with water to form an aqueous silicon emulsion. The surfactants may be the same as previously described.

In an embodiment, a silanated organoclay resulting from treatment of an organoclay with a silicon compound may be subjected to high shearing in a suitable mill (e.g., Manton-Gaulin mill). In certain embodiments, an organoclay composition may be subjected to a high shear treatment prior to treatment with a silicon compound. In the mill, passing the silanated organoclay composition through a narrow gap at high velocities may produce a high-speed fluid shear of the silanated organoclay composition. A high-pressure differential may be maintained across the gap. The pressure differential across the gap may be less than about 8,000 psig. The silanated organoclay composition may be passed through the mill one or more times. Different arrangements of the milling equipment components may be utilized to provide high shearing of the organoclay. The use of high shear may disperse the silanated organoclay composition into individual platelets such that dispersion of the silanated organoclay composition may be enhanced during addition of the composition to an organic matrix. Following a high shear step, a silanated organoclay composition may be subjected to other processing treatments including, but not limited to, filtering, milling and/or drying.

In an embodiment, a silanated clay composition and/or a silanated organoclay composition may be used in aqueous based coating or polymerization processes (e.g., emulsion process, rubber process, latex process). In some embodiments, a silanated clay composition and/or a silanated organoclay composition may be used in aqueous systems in which improved rheological and/or thickening properties may be desired (e.g., drilling fluids, paints, ceramics). Examples of a silanated clay composition used to improve rheological properties are described in U.S. Pat. No. 5,292,908 to Onikata et al. and to U.S. Pat. No. 5,491,248 to Kondo et al., both of which are incorporated by reference herein.

In certain embodiments, a silanated clay composition and/or silanated organoclay composition may be used as a nanofiller and mixed with a monomer and/or polymer system to form a modified nanocomposite. As used herein, the term “nanofiller” generally refers to a particulate filler or additive whose particle dimensions are generally in the nanometer range. In some embodiments, nanofillers may include clay and/or organoclay compositions. In some embodiments, nanofillers may include silanated clay and/or silanated organoclay compositions. In an embodiment, the monomer and/or polymer system may be substantially compatible with the silanated clay composition and/or silanated organoclay composition. Such an embodiment may advantageously obviate the need for an external compatibilizing material. As used herein, the term “compatibilizing material” or “compatibilizer” generally refers to a material that enhances the compatibility between a polar nanofiller, such as, for example, a clay, and nonpolar constituents of a monomer and/or polymer system. While compatibilizing materials may, in certain instances, impart desirable properties, such as for example, flexural modulus and coefficient of linear thermal expansion, on the nanocomposites produced therewith, their inclusion may substantially increase the cost associated with producing nanocomposites. A non-limiting example of a compatibilizing material may include maleated polypropylene (MAPP). The inclusion of MAPP in a non-polar polymer system may enhance the compatibility between a polyolefin and a polar filler material. Other examples of compatibilizing materials may include onium-containing compounds and/or other compounds with increased polarity associated with the monomer and/or polymer system.

The silanated clay composition and/or silanated organoclay composition may be compounded into a monomer and/or polymer system through an extrusion process. In certain embodiments, a twin-screw extruder may be used to compound a silanated clay composition and/or silanated organoclay composition into a monomer and/or polymer system. Other types of mixing and/or extrusion processes may be used to combine the silanated clay composition and/or a silanated organoclay composition with a monomer and/or polymer system prior to a polymerization step. Once polymerization commences, the silanated clay composition and/or silanated organoclay composition may be incorporated into the monomer and/or polymer system in situ to form a polymerized material. The resulting polymerized material may be processed to form pellets, prills or other forms that may be used in the further processing of polymeric materials (e.g., film production, thermoforming, blow molding or injection molding).

A film may be produced by melt extrusion, blown film extrusion and/or cast film extrusion of one or more high molecular weight hydrocarbon polymers. At least a portion of a solid polymer may be fed into an extruder at a temperature above the melting point of the solid polymer. A rotating screw in the extruder may force at least a portion of the viscous polymer melt through a barrel of the extruder into a die orifice. The resulting formed extrudate may be quenched and/or allowed to cool slowly to a temperature below the melting point of the polymer. The formed extrudate may solidify and assume the shape of a die orifice. For cast film extrusion, a gapped coat hanger die may be used to lay a melt of modified polymer onto a roller. The film may then be fed through a nip roller and onto a take-up roll.

A silanated clay composition and/or a silanated organoclay composition may impart favorable characteristics in production of fibers from monomer and/or polymer systems. For example, addition of a silanated clay composition and/or a silanated organoclay composition to fibers may impart improved mechanical characteristics (e.g., increased tensile strength and/or increase flexural modulus) to the fibers. The addition of a silanated clay composition and/or a silanated organoclay composition to fibers may impart improved extrusion characteristics of the fibers.

A silanated clay composition and/or a silanated organoclay composition may impart favorable characteristics in injection molding processes and/or in blow molding processes of monomer and/or polymer systems. For example, addition of a silanated clay composition and/or a silanated organoclay composition to a monomer and/or polymer system may impart improved form release characteristics in an injection molding process. The silanated clay composition and/or silanated organoclay composition may impart to the monomer and/or polymer system a more accurate replication characteristics of a molded product from the die form in the injection molding processes. Blow molding processes of a monomer and/or polymer system may exhibit improved surface structure features when a silanated clay composition and/or a silanated organoclay composition is included with the monomer and/or polymer system.

A silanated clay composition and/or a silanated organoclay composition may be mixed with various polymerizable organic materials to produce a number of different products or articles (e.g. nanocomposites). Inclusion of the silanated clay composition and/or the silanated organoclay composition into the monomer and/or polymer system may impart improved mechanical properties (e.g., flexural modulus, tensile strength) over the original monomer and/or polymer system. Nanocomposite formulations that include a monomer and/or polymer system and a silanated clay composition and/or a silanated organoclay composition may also impart improved surface characteristics of the resulting silanated clay composition and/or a silanated organoclay composition treated monomer and/or polymer system over the original monomer and/or polymer system.

Rubber-toughened thermoplastic nanocomposites may include, but are not limited to, a blend of a thermoplastic engineering monomer and/or polymer system, an elastomeric functionalized copolymer and a silanated clay composition and/or a silanated organoclay composition. Inclusion of a silanated clay composition and/or a silanated organoclay composition with a rubber-toughened thermoplastic nanocomposite materials may impart substantially improved mechanical characteristics of the resulting silanated clay composition and/or a silanated organoclay composition treated rubber-toughened nanocomposite.

A rubber composition may include a silanated clay composition and/or a silanated organoclay composition. Inclusion of the silanated clay composition and/or the silanated organoclay composition may impart increased flexural modulus to the rubber composition. For example, the formed rubber composition may be used in the manufacture of automobile tires.

Improved barrier properties of polyesters (e.g., polyethylene terephthalate) may be important in bottles and containers that store carbonated beverages, fruit juices and/or foods. Containers made from polyethylene terephthalate are not generally used for products requiring long shelf life due to limited barrier properties with regard to oxygen, carbon dioxide and other gases.

Addition of a silanated clay composition and/or a silanated organoclay composition to a polyester composite material (e.g., polyethylene terephthalate) may impart improved gas barrier characteristics to the polyester composite material. The silanated clay composition and/or a silanated organoclay composition may be mixed with the polyester composite by a procedure such as melt mixing or spray drying. The resulting silanated clay composition and/or a silanated organoclay composition treated polyester composite may be processed into containers. U.S. Pat. No. 6,060,549 to Li, et al. and U.S. Pat. No. 6,034,163 to Barbee, et al., both of which are incorporated herein by reference, describe organoclays in polyester compositions.

Typically, manufactured articles made from molten polymers and/or nanocomposite materials using injection molding or casting techniques undergo a certain amount of shrinkage after the molded or cast article is formed and the molten material has substantially solidified. It has been advantageously found that the nanocomposites embodied herein may shrink less than those nanocomposites produced using alternate nanofillers, such as, for example, a nanocomposite made by mixing a non-silanated clay or a non-silanated organoclay with a monomer and/or polymer system in the presence of a compatibilizing material. The amount of shrinkage that a nanocomposite undergoes may typically be measured after the molten composition has returned to a substantially solid state. In an embodiment, the shrinkage of a molded article produced using a nanocomposite may be measured, for example as stated above, about 48 hours after the article was molded. Shrink measurement may be obtained, in an embodiment, by comparing the dimensions of a molded article with the dimensions of the mold used to make the article. Using this technique, shrink measurements of nanocomposite articles made using different clay and/or organoclay formulations may be compared.

The mean free path (mfp) of a nanocomposite material may be used as a rough estimation of the degree to which a material, such as a nanofiller, has exfoliated in a polymer matrix. Typically, mfp measurements are made using transmission electron microscopy (TEM) images of nanofiller particles that are dispersed in the matrix. In an embodiment, a nanocomposites made using a silanated clay and/or a silanated organoclay composition may have mean free paths as set forth hereinabove.

In the following examples, the percent weight loss on ignition (LOI) value may indicate the extent of reaction of a silicon compound and/or onium compound with a clay. A high LOI value may indicate an increased concentration of the silicon compound and/or onium compound in the clay. The LOI for the following examples was determined by drying the sample at about 105° C. for about 2 hours. After heating, a moisture content of the silicon clay composition and/or silicon organoclay composition was determined by generally known methods. The dried sample was heated at about 980° C. for about 90 minutes. After heating, a weight loss of the silicon clay composition and/or silicon organoclay composition was determined. Table 1 is a compilation of the example data and comparison data. Table 1 also lists the Loss on Ignition (LOI) values for some organosilane and organoclay compositions. Loss On Ignition (LOI) values are reported to indicate the extent of reaction of the organosilane with the organoclay product. The higher the LOI value, the more organosilane that may be reacted with the clay. Addition of the quaternary onium compound may also increase the LOI.

### EXAMPLE 1

### Control

Montmorillonite (Cloisite® Na⁺, manufactured by Southern Clay Products, Gonzales, Tex.) was added to enough water to produce a clay slurry of about 3% by weight of montmorillonite. The montmorillonite slurry was heated to a temperature of about 65° C. A pH of the montmorillonite slurry was measured and a pH value of about 8.2 was reported. The montmorillonite slurry was dried in a blower oven overnight to remove excess water. After drying, the montmorillonite was milled. An LOI value of 6.65% was determined for the milled organoclay. The milled montmorillonite was washed twice with methanol, dried and an LOI value of about 6.59% was obtained for the washed montmorillonite.

### EXAMPLE 2

About 3% by weight of montmorillonite (Cloisite® Na⁺) was slurried in water. The aqueous montmorillonite slurry was heated to about 65° C. A pH was measured and a pH value of about 8.2 was reported. About 3% by weight, based on a dry clay weight, of n-octyltriethoxysilane (e.g. Z-6341, manufactured by Dow Corning, Midland, Mich.) was added, with stirring, to the heated montmorillonite slurry. The aqueous montmorillonite/n-octyltriethoxysilane slurry was heated to a temperature of about 65° C. The montmorillonite/n-octyltriethoxysilane slurry was held at about 65° C. for about 1 hour. The resulting aqueous silanated montmorillonite composition was dried in a blower oven at about 110° C. overnight. The dried silanated montmorillonite composition was milled. A LOI value of about 6.51% was determined for the silanated montmorillonite composition.

### EXAMPLE 3

About 3% by weight of montmorillonite (Cloisite® Na⁺) was slurried in water. The pH of the aqueous montmorillonite slurry was adjusted to a pH value of about 4.0 with hydrochloric acid. About 3% by weight, based on a dry clay weight, of n-octyltriethoxysilane was added, with stirring, to the heated pH adjusted aqueous montmorillonite slurry. The aqueous montmorillonite/n-octyltriethoxysilane slurry was heated to a temperature of about 65° C. The heated slurry was held at about 65° C. for about 1 hour. The resulting aqueous silanated montmorillonite composition was dried in a blower oven at about 110° C. overnight. The dried silanated montmorillonite composition was milled. A LOI value of about 8.27% was determined for the silanated montmorillonite composition.

### EXAMPLE 4

About 3% by weight of montmorillonite (Cloisite® Na⁺) was slurried in water. The pH of the aqueous montmorillonite slurry was adjusted to a pH value of about 7.0 with hydrochloric acid. About 3% by weight, based on a dry clay weight, of an n-octyltriethoxysilane was added, with stirring, to the heated pH adjusted aqueous montmorillonite slurry. The aqueous montmorillonite/n-octyltriethoxysilane slurry was heated to a temperature of about 65° C. The heated slurry was held at about 65° C. for about 1 hour. The resulting aqueous silanated montmorillonite composition was dried in a blower oven at about 110° C. overnight. The dried silanated montmorillonite composition was milled. A LOI value of about 7.77% was determined for the silanated montmorillonite composition.

### EXAMPLE 5

About 3% by weight of montmorillonite (Cloisite®Na⁺) was slurried in water. The pH of the aqueous montmorillonite slurry was adjusted to a pH value of about 4.0 with sulfuric acid. About 3% by weight, based on a dry clay weight, of polydimethylsiloxane (e.g., UCT PS-343.8 (molecular weight about 60,000) manufactured by United Chemical Technologies, Bristol, Pa.) was added, with stirring, to the heated pH adjusted aqueous montmorillonite slurry. The aqueous montmorillonite/siloxane slurry was heated to a temperature of about 65° C. The heated slurry was held at about 65° C. for about 1 hour. The resulting aqueous silanated montmorillonite composition was dried in a blower oven at a temperature of about 110° C. overnight. The dried silanated montmorillonite composition was milled. A LOI value of about 9.25% was determined for the silanated montmorillonite composition.

### EXAMPLE 6

About 3% by weight of montmorillonite (Cloisite®Na⁺) was slurried in water. The pH of the aqueous montmorillonite slurry was adjusted to a pH value of about 4.0 with sulfuric acid. About 3% by weight, based on a dry clay weight, of n-octyltriethoxysilane was added, with stirring, to the heated pH adjusted aqueous montmorillonite slurry. The aqueous montmorillonite/n-octyltriethoxysilane slurry was heated for about two minutes at a temperature of about 65° C. About 95 milliequivalents of dimethyl di(hydrogenated tallow) ammonium chloride were added to the aqueous montmorillonite/n-octyltriethoxysilane slurry. The resulting mixture was held at about 65° C. for about 45 minutes. The resulting silanated organoclay composition was then subjected to high shear mixing, filtered, dried and milled. A LOI value of about 39.21% was determined for the silanated organoclay composition.

### EXAMPLE 7

About 3% by weight of montmorillonite (Cloisite® Na⁺) was slurried in water. The pH of the aqueous montmorillonite slurry was adjusted to a pH value of about 3.8 with sulfuric acid. About 3% by weight, based on a dry clay weight, of n-octyltriethoxysilane was added, with stirring, to the heated pH adjusted aqueous montmorillonite slurry. The aqueous montmorillonite/n-octyltriethoxysilane slurry was heated for about two minutes at a temperature of about 65° C. After two minutes, about 125 milliequivalents of dimethyl di(hydrogenated tallow) ammonium chloride was added to the aqueous montmorillonite/n-octyltriethoxysilane slurry. The resulting mixture was held at about 65° C. for about 45 minutes. The resulting aqueous silanated organoclay slurry was then subjected to high shear mixing, filtered, dried, and milled. A LOI value of about 45.31% was determined for the silanated organoclay composition.

### EXAMPLE 8

About 3% by weight of montmorillonite (Cloisite® Na⁺) was slurried in water. The pH of the aqueous montmorillonite slurry was adjusted to a pH value of about 4.0 with sulfuric acid. About 3% by weight, based on a dry clay weight, of polydimethylsiloxane (e.g., UCT PS-343.8 (molecular weight about 60,000) manufactured by United Chemical Technologies, Bristol, Pa.) was added, with stirring, to the heated pH adjusted montmorillonite slurry. The aqueous montmorillonite/organosiloxane slurry was heated to a temperature of about 65° C. The heated slurry was held at about 65° C. for about 1 hour. About 125 milliequivalents of dimethyl di(hydrogenated tallow) ammonium chloride were added to the aqueous montmorillonite/organosiloxane slurry. The resulting mixture was heated to a temperature of about 65° C. The heated mixture was held at about 65° C. for about 45 minutes. The resulting aqueous silanated organoclay slurry was then subjected to high shear mixing, filtered, dried, and milled. A LOI value of about 44.33% was determined for the silanated organoclay composition.

TABLE 1

| | | | | | | Onium | |
|---|---|---|---|---|---|---|---|
| | Example | Reaction | | | Silicon | amount in | |
| Entry No. | No. | Temp. ° C. | Acid | pH | Compound | MER | LOI |
| 1 | 1 | 65 | — | 8.2 | — | — | 6.65 |
| 2 | 2 | 65 | — | 8.2 | Z-6341 | — | 6.51 |
| 3 | | 65 | H₃PO₄ | 4.0 | Z-6341 | — | 7.50 |
| 4 | | 65 | H₃PO₄ | 7.0 | Z-6341 | — | 7.36 |
| 5 | 3 | 65 | HCl | 4.0 | Z-6341 | — | 8.27 |
| 6 | 4 | 65 | HCl | 7.0 | Z-6341 | — | 7.77 |
| 7 | | 65 | H₂SO₄ | 4.0 | Z-6341 | — | 8.60 |
| 8 | | 65 | H₂SO₄ | 7.0 | Z-6341 | — | 7.91 |
| 9 | | 65 | H₂SO₄ | 4.0 | PS-341 | — | 9.05 |
| 10 | 5 | 65 | H₂SO₄ | 4.0 | PS-343.8 | — | 9.25 |
| 11 | | 65 | H₂SO₄ | 4.0 | PS-345.5 | — | 9.45 |
| 12 | | 65 | — | 8.2 | — | 2M2HT/95 | 37.88 |
| 13 | | 65 | — | 8.2 | — | 2M2HT/125 | 44.48 |
| 14 | | 65 | — | 8.2 | Z-6341 | 2M2HT/125 | 44.00 |
| 15 | 6 | 65 | H₂SO₄ | 4.0 | Z-6341 | 2M2HT/95 | 39.21 |
| 16 | 7 | 65 | H₂SO₄ | 3.8 | Z-6341 | 2M2HT/125 | 45.31 |
| 17 | | 65 | H₂SO₄ | 4.0 | PS-341 | 2M2HT/125 | 44.20 |
| 18 | 8 | 65 | H₂SO₄ | 4.0 | PS-343.8 | 2M2HT/125 | 44.33 |
| 19 | | 65 | H₂SO₄ | 4.0 | PS-345.5 | 2M2HT/125 | 44.30 |

Z-6341 is Dow Corning n-octyltriethoxysilane
PS-341 is United Chemical Technologies (UCT) Polydimethylsiloxane MW ˜11,000
PS-343.8 is UCT Polydimethylsiloxane MW ˜60,000
PS-345.5 is UCT Polydimethylsiloxane MW ˜74,000
2M2HT is Dimethyl di(hydrogenated tallow) ammonium chloride
MER is milliequivalent ratio of quaternary ammonium compound to clay

Surfactant Evaluations: To facilitate the treatment of the clay with a silicon compound experiments were performed to identify a surfactant that produced an emulsion with the silicon compound and water.

A specified amount of silicon compound, surfactant and water were added to a bottle and the mixture was shaken. A surfactant was determined to be suitable if the criteria of a) silicon compound and surfactant were miscible and b) formation of a stable emulsion (e.g. formation of a milky solution that remained milky overnight) was met. Table 2 is a compilation of silicon compound, surfactant and water experiments.

TABLE 2

| Entry | Silicon Compound | Surfactant | | | Milky after | Stable |
|---|---|---|---|---|---|---|
| No. | (amount, g) | (amount, g) | Miscible | Water, g | mixing | Emulsion |
| 1 | Phenyl silane (0.09) | IGEPAL ® CO 430 | Yes | | | |
| 2 | PDMS (0.09) | IGEPAL ® CO 430 | No | | | |
| 3 | | IGEPAL ® CO 430 (0.5) | | 50 | No -2 | |
| | | | | | phases | |
| 4 | Phenyl (0.09) | IGEPAL ® CO 887 (0.5) | Yes | 50 | Yes | |
| 5 | PDMS (0.09) | IGEPAL ® CO 887 (0.05) | No | 50 | Yes | |
| 6 | Phenyl (0.1) | IGEPAL ® CO 887 (0.01) | Yes | 175 | Yes/No, | No |
| | | | | | Small balls | |
| 7 | Phenyl (1.0) | IGEPAL ® CO 887 (0.1) | Yes | 175 | No, Small | No |
| | | | | | balls | |
| 8 | Phenyl (1.0) | IGEPAL ® CO 887 (0.3) | Yes | 175 | Milky | No |
| 9 | PDMS (0.1) | PS071 (0.1) | No | 50 | Milky | |
| 10 | Phenyl (0.1) | PS071 (0.1) | Yes | 50 | Milky | |
| 11 | PDMS (0.1) | PS073 (0.1) | No | 50 | No | |
| 12 | Phenyl (0.1) | PS073 (0.1) | Yes | 50 | No | |
| 13 | PDMS (0.5) | PS071 (0.05) | Milky | 50 | Milky | Yes |
| 14 | PDMS (0.5) | PS071 (0.01) | Milky | 50 | Milky | Yes |
| 15 | Phenyl (0.5) | PS071 (0.05) | Yes | 50 | Milky | Yes |
| 16 | Phenyl (0.5) | PS071 (0.05) | Yes | 50 | Milky | Yes |
| 17 | A-1289 (0.5) | PSO71 (0.05) | Yes | 50 | Milky | Yes |

IGEPAL ® CO 887 Nonylphenyl Ethoxylate manufactured by Rhodia Corporation.
IGEPAL ® CO 430, Nonyl phenol ethoxylate (4 moles EO) manufactured by Rhodia Corporation.
PDMS = Polydimethylsiloxane manufactured by United Chemical Technologies, Bristol, PA.
PS073 - ethoxylated polydimethylsiloxane-MW ˜3126- (EO 82%) United Chemical Technologies
PSO71 - ethoxylated polydimethylsiloxane-MW ˜600 (EO-75%)-United Chemical Technologies
A-1289 = bis(triethoxysilylproply)tetrasulfide manufactured by Crompton Corporation, Middlebury, CT

### EXAMPLE 9

About 3% by weight of montmorillonite (Cloisite® Na⁺) was slurried in water. The aqueous montmorillonite slurry was heated to a temperature of about 65° C. The pH of the heated aqueous montmorillonite slurry was adjusted to a pH value of about 4.0 with sulfuric acid.

About 3% by weight, based on a dry clay weight, of bis(triethoxysilylpropyl)tetrasulfide (e.g., Silquest A-1289 manufactured by Crompton Corporation, Middlebury, Conn.) and 0.3% by weight, based on a dry montmorillonite weight, of nonylphenol ethoxylate (e.g. IGEPAL® CO 887) were combined in 90% to 98% water to form an emulsion of bis(triethoxysilylpropyl)tetrasulfide and surfactant.

The bis(triethoxysilylpropyl)tetrasulfide/surfactant emulsion was added, with stirring, to the heated aqueous montmorillonite slurry. The aqueous slurry of montmorillonite, bis(triethoxysilylpropyl)tetrasulfide, and surfactant was held at a temperature of about 65° C. for about 1 hour. About 125 milliequivalents of dimethyl di(hydrogenated tallow) ammonium chloride were added to the montmorillonite/bis(triethoxysilylpropyl)tetrasulfide/surfactant slurry. The resulting mixture was heated to 65° C. The heated slurry was held at a temperature of about 65° C. for about 45 minutes. The resulting aqueous silanated organoclay composition was then subjected to high shear mixing, filtered, dried, and milled. A LOI value of about 45.07% was determined for the silanated organoclay composition.

### EXAMPLE 10

About 3% by weight of montmorillonite (Cloisite® Na⁺) was slurried in water. The aqueous montmorillonite slurry was heated to about 65° C. The pH of the aqueous montmorillonite slurry was adjusted to a value of about 4.0 with sulfuric acid. About 3% by weight, based on a dry clay weight, of bis(triethoxysilylpropyl)tetrasulfide was added, with stirring, to the heated aqueous montmorillonite slurry. The aqueous slurry of montmorillonite and bis(triethoxysilylpropyl)tetrasulfide was held at a temperature of about 65° C. for about 1 hour. About 125 milliequivalents of dimethyl di(hydrogenated tallow) ammonium chloride was added to the montmorillonite/bis(triethoxysilylpropyl)tetrasulfide slurry. The resulting mixture was heated at a temperature of about 65° C. for about 45 minutes. The resulting aqueous silanated organoclay composition was then subjected to high shear mixing, filtered, dried, and milled. A LOI value of about 44.71% was determined for the silanated organoclay composition.

### EXAMPLE 11

A clay was prepared as previously described in the previous examples (e.g., protonated with sulfuric acid, contacted with a siloxane (e.g. PS 343.5, manufactured by United Chemical Technologies, Bristol, Pa.) or a phenyl silane and a methyl dehydrogenated tallow amine) and incorporated into a monomer and/or polymer system (e.g., Capron B85QP manufactured by Honeywell, Morristown, N.J.). Pellets of the nanocomposite were melted in a single screw extruder. For a cast film, the melt was fed into a gapped T die to produce a melt of polymer down onto a roller. The nanocomposite melt was fed through a nip roller and onto a take-up roller. Alternatively, a blown film was made by feeding the nanocomposite melt through an annular die, blowing air into the inside of the bubble, collapsing the bubble, and feeding the nanocomposite melt onto a take-up roller.

Films of 1.5 mils, 1.0 mils and 0.5 mils thickness were produced. The silanated organoclay composition substantially reduced globular imperfections in the produced film.

### EXAMPLE 12

A sample of silanated organoclay was incorporated into ethylene vinyl alcohol. Dispersion of the silanated organoclay was found to be better than untreated organoclay as monitored by transmission electron microscopy (TEM).

### EXAMPLE 13

Silicon compounds were evaluated in polymerizable organic nanocomposite to determine tensile strength and/or flexural modulus. Table 3 is a compilation of the test results for the various systems.

About 5% by weight of montmorillonite (Cloisite® Na⁺) was slurried in water. The aqueous montmorillonite slurry was heated to a temperature of about 65° C. The pH of the heated aqueous montmorillonite slurry was adjusted to a pH value of about 4.0 with sulfuric acid.

About 3% by weight, based on a dry clay weight, of a silicon compound (e.g., octyltriethoxysilane, phenyl triethoxysilane, bis(triethoxysilylpropyl)tetrasulfide and polydimethylsiloxane) and 0.3% by weight, based on a dry montmorillonite weight, of a surfactant (e.g. IGEPAL® CO 887, PSO71) were combined in water 90% to 98% by weight to form a silicon compound/surfactant emulsion.

The silicon compound/surfactant emulsion was added, with stirring, to the heated aqueous montmorillonite slurry. The aqueous montmorillonite/silicon compound/surfactant slurry was held at a temperature of about 65° C. for about 1 hour. About 125 milliequivalents of dimethyl di(hydrogenated tallow) ammonium chloride were added to the montmorillonite/silicon compound/surfactant slurry. The resulting mixture was heated to 65° C. The heated slurry was held at a temperature of about 65° C. for about 45 minutes. The resulting aqueous silanated organoclay composition was then subjected to high shear mixing, filtered, dried and milled.

About 5 wt. % resulting silanated organoclay composition was incorporated into a monomer and/or polymer system (e.g. Profax® 6301, polypropylene homopolymer) and the flexural modulus and tensile strength were determined using American Society of Testing Methods D 790-02 and D638-02a. About 5 wt. % of a maleated polypropylene (e.g., Polybond® 3200, Crompton Corporation, Middlebury, Conn.) was added to the monomer and/or polymer system and used as a reference compound. About 5 wt. % of montmorillonite contacted with methyl di(hydrogenated tallow) ammonium chloride (e.g., Cloisite® 15A, manufactured by Southern Clay Products, Gonzales, Tex.) was incorporated into a monomer and/or polymer system and used as a reference compound.

TABLE 3

| | | | | Flex | | Tensile | | |
|---|---|---|---|---|---|---|---|---|
| Entry | | % | Silicon Compound/ | Modulus* | Strength | Modulus | Strength | Elongation |
| No. | Clay | MAPP | Surfactant | kpsi | psi | kpsi | Psi | % |
| — | — | | — | 199 | 3807 | 183 | 4530 | 9 |
| 1 | Cloisite ® 15A | 0 | — | 257 | 6864 | 261 | 4342 | 7 |
| 2 | Cloisite ® 15A | 5 | — | 303 | 7548 | 271 | 4543 | 8 |
| 3 | Montmorillonite | 0 | PS343.8/PS071 | 334 | 7397 | 325 | 4731 | 7 |
| 4 | Montmorillonite | 0 | PS343.8/ | 263 | 6634 | 249 | 4233 | 7 |
| | | | Igepal CO 887 | | | | | |
| 5 | Montmorillonite | 0 | PO330/PS071 | 313 | 7040 | 276 | 4626 | 7 |
| 6 | Montmorillonite | 0 | O9835/PS071 | 313 | 7229 | 289 | 4691 | 7 |
| 7 | Montmorillonite | 0 | O9835 | 266 | 6683 | 263 | 4398 | 7 |
| 8 | Montmorillonite | 0 | A-1289/PS071 | 333 | 7348 | 337 | 4410 | 8 |
| 9 | Montmorillonite | 0 | A-1289 | 338 | 7586 | 335 | 4636 | 8 |
| 10 | Montmorillonite | 0 | M8850/DHBP/PS071 | 278 | 6869 | 275 | 4516 | 23 |
| 11 | Montmorillonite | 0 | V3971/DHBP/PS071 | 302 | 7399 | 293 | 4123 | 19 |

PS-343.8 Polydimethylsiloxanes, silanol terminated, M_{N} ˜60,000 United Chemical Technologies (UCT)
PO-330 Phenyl triethoxysilane United Chemical Technologies (UCT)
O-9835 Octyl triethoxysilane United Chemical Technologies (UCT)
A-1289 bis(Triethoxysilylpropyl)tetrasulfide United Chemical Technologies (UCT)
Igepal CO-887 Rhodia Inc.
PSO71-Ethoxylated polydimethylsiloxane-MW ˜600- United Chemical Technologies
M8550 3-Methylacrylproplyl trimehtoxsilane- United Chemical Technologies
V4917 Vinyl triethoxysilane- United Chemical Technologies
DHBP 2,5-Dimethyl-2,5-(butylperoxy)hexane - Aztec Peroxides
*determined at the University of Texas, Austin, TX

### EXAMPLE 14

Silanated organoclay compositions were incorporated into polyamide 6 to determine the number of defects associated with clay agglomeration in the silanated organoclay polyamide system.

Entry 1: About 5 wt. % of montmorillonite contacted with methyl di(hydrogenated tallow) ammonium hydrogen sulfate (e.g., Cloisite® 93A, manufactured by Southern Clay Products, Gonzales, Tex.) was incorporated into polyamide 6. Surface defects present in the film had an appearance of a gel or unmelted polymer. The resulting organoclay polyamide system was used as a reference system.

Entry 2 and 3: Montmorillonite, contacted with methyl di(hydrogenated tallow) ammonium hydrogen sulfate (e.g., Cloisite® 93A), was contacted with about 3 wt %, based on dry montmorillonite, of a silicon compound (e.g., phenyl silane, polydimethysiloxane) as previously described. About 5 wt. % of the resulting silanated organoclay was incorporated into polyamide 6.

Infrared spectroscopy coupled with a microscope and transmission electron microscopy was use to identify the surface defects contained agglomeration of montmorillonite. The number of defects associated with clay agglomeration on a per square inch basis. Table 4 is a compilation of agglomeration test results for silanated organoclay compositions.

TABLE 4

| Entry | | | No. of Agglomerate |
|---|---|---|---|
| No. | Clay | Silicon Compound | defects/sq. in. |
| 1 | Cloisite ® 93A | — | 36 |
| 2 | Cloisite ® 93A | Phenyl silane | 46 |
| 3 | Cloisite ® 93A | PS343.8 | 6 |

### EXAMPLE 15

Silanated organoclay compositions were incorporated into an injected molded part to determine the amount of agglomerates associated with clay agglomeration in the part.

Silanated organoclay compositions were prepared according to the procedure described in Example 8 (Table 1, entry 15). About 5 wt. % of the resulting silanated organoclay was incorporated into an injected molded part.

Montmorillonite contacted with dimethyl di(hydrogenated tallow) ammonium chloride (e.g., Cloisite® 20A, manufactured by Southern Clay Products, Gonzales, Tex.) was incorporated into an injected molded part. About 5 wt. % of resulting organoclay molded part was used as a reference system.

Agglomerates associated with clay agglomeration greater than 40 microns in a field of 1524 microns by 1905 microns were counted using visual inspection. For reference, a naked eye may see agglomerates greater than 50 microns in a class A surface finish part. Table 5 is a compilation of agglomeration test results for silanated organoclay compositions

TABLE 5

| Entry | | | No. of Agglomerates |
|---|---|---|---|
| No. | Clay | Silicon Compound | above 40 microns |
| 1 | Cloisite 20 ® A | — | 63 |
| 2 | Montmorillonite | n-octyltriethoxysilane | 4 |

Hydroxyl groups are embedded in the structure of nanoclay sheets, as well as around the edges of the sheets. The embedded hydroxyls are sterically hindered and not available for reaction, but those around the edges are available for reaction with functional groups, non-limiting examples of which include the reactive groups of silane compounds. The reactive groups of various organosilane compounds were reacted with the silicates of the nanoclay sheets. These clays were then incorporated in embodiments of the nanocomposite materials and evaluated.

### EXAMPLE 16

Scaled-up experiments were performed on some of the formulations to determine whether scaling up the components and production of the nanocomposites embodied herein affected the quality of the resulting nanocomposites. It was advantageously found that scaled-up formulations also exhibited generally equivalent fortuitous physical properties, such as flexural modulus.

The nanocomposite formulations according to some embodiments have many advantages. One non-limiting advantage is that the embodiments may be more cost effective to produce than formulations prepared using an external compatibilizer, while providing essentially the same or improved physical properties. In addition to the desirable physical properties obtained using clay and organoclay formulations presented herein, it has been discovered that using these nanofillers without an external compatibilizer substantially prevents undesirable agglomeration of the clay during processing, thereby further substantially improving the quality of the surface of the molded nanocomposite materials or films made therewith.

Nanocomposites in general are lighter weight, higher performance materials than thermoplastics that are filled with conventional filler materials such as, for example, talc or standard clays or organolcays. As stated above, external compatibilizers were previously required to produce nanocomposites using clay nanofillers. It is believed that reacting clays with silane compounds using the methods embodied herein may enable production of the novel nanocomposites without using the external compatibilizer. This results in nanocomposite materials with high aspect ratios and high dispersion, thus leading to an increase in flexural modulus at a potentially significant cost reduction.

As discussed further hereinabove, it is believed that the modified nanofillers as described herein may advantageously impart improved characteristics to the nanocomposite material(s) including, but not limited to, increased tensile strength, increased tensile modulus, increased flexural strength, increased flexural modulus, increased barrier properties, increased dimensional stability, increased heat distortion temperature properties, reduction of defects in films and/or reduction of surface defects in molded parts.

Certain U.S. patents have been incorporated herein by reference. The text of such U.S. patents is, however, only incorporated by reference to the extent that no conflict exists between such text and the other statements and drawings set forth herein. In the event of such conflict, then any such conflicting text in such incorporated by reference U.S. patents is specifically not incorporated by reference in this patent.

Further modifications and alternative embodiments of various aspects of the disclosure will be apparent to those skilled in the art in view of this description. Accordingly, this description is to be construed as illustrative only and is for the purpose of teaching those skilled in the art the general manner of carrying out the embodiments. It is to be understood that the forms of the disclosure shown and described herein are to be taken as examples of embodiments. Elements and materials may be substituted for those illustrated and described herein, parts and processes may be reversed, and certain features of the embodiments may be utilized independently, all as would be apparent to one skilled in the art after having the benefit of this description of the invention. Changes may be made in the elements described herein without departing from the spirit and scope of the disclosed embodiments as described in the following claims.

1. A nanocomposite material, comprising:
at least one polymeric material; and
at least one modified nanofiller material having shielded polar groups, wherein the at least one polymeric material is compatible with the modified nanofiller without an external compatibilizing material;
wherein the nanocomposite material exhibits enhanced physical properties.

2. The nanocomposite material as defined in claim 1, wherein the polymeric material comprises thermoplastic materials.

3. (canceled)

4. The nanocomposite material as defined in claim 1, wherein the polymeric material comprises at least one of polypropylene homopolymers, impact modified polypropylenes, ethylene-propylene elastomers, and mixtures thereof.

5. The nanocomposite material as defined in claim 1, wherein the modified nanofiller comprises a modified clay which is at least one of smectite, hectorite, montmorillonite, bentonite, beidellite, saponite, stevensite, sauconite, nontronite, illite, and mixtures thereof.

6. The nanocomposite material as defined in claim 5, wherein the modified clay is modified with an active silane material of the general formula, —RₓSi(OR′)₍₄₋ₓ₎, wherein R is a functional group chosen from at least one of methyl, ethyl, phenyl, n-octyl, n-octadecyl, 2-ethylhexyl, n-dodecyl, and mixtures thereof; and wherein R′ is a functional group chosen from at least one of methyl, ethyl, isopropyl, n-butyl, isobutyl, and mixtures thereof.

7. (canceled)

8. The nanocomposite material as defined in claim 5, wherein the modified nanofiller is at least one of sodium montmorillonite treated with phenyltriethoxysilane, sodium montmorillonite treated with n-octadecyltriethoxysilane, sodium montmorillonite treated with n-octyltriethoxysilane, and mixtures thereof.

9. The nanocomposite material as defined in claim 1, wherein the nanocomposite material is adapted for use as at least one of an automotive interior body material and an automotive exterior body material.

10. The nanocomposite material as defined in claim 1, wherein the nanocomposite material has a flexural modulus ranging between about 814 MPa and about 2144 MPa.

11. (canceled)

12. (canceled)

13. The nanocomposite material as defined in claim 1, wherein the nanocomposite material shrinks less than a nanofilled material containing the at least one polymeric material, an organoclay, and an external compatibilizing material, shrink being measured about 48 hours after molding the nanocomposite material.

14. The nanocomposite material as defined in claim 13, wherein the organoclay is a sodium montmorillonite clay treated with dimethyl, dihydrogenated tallow quaternary ammonium chloride.

15. The nanocomposite material as defined in claim 1, wherein the nanocomposite material has a transmission electron microscopy mean free path ranging between about 0.23 and about 0.64.

16. (canceled)

17. The nanocomposite material as defined in claim 1, wherein the nanocomposite material has an aspect ratio ranging between about 100 and about 200.

18. (canceled)

19. A workpiece, comprising:
a member molded from a nanocomposite material, including:
at least one polymeric material; and
at least one modified nanofiller material having shielded polar groups, wherein the at least one polymeric material is compatible with the modified nanofiller without an external compatibilizing material; and
wherein the nanocomposite material exhibits enhanced physical properties; and a surface on the member, the surface being substantially free from surface defects.

20. The workpiece as defined in claim 19, wherein the member is adapted for use as at least one of an automotive interior body material and an automotive exterior body material.

21. The workpiece as defined in claim 19, wherein the nanocomposite material has a flexural modulus ranging between about 814 MPa and about 2144 MPa.

22. The workpiece as defined in claim 21, wherein the polymeric material comprises at least one of polypropylene homopolymers, impact modified polypropylenes, ethylene-propylene elastomers, and mixtures thereof; and wherein the modified nanofiller is at least one of sodium montmorillonite treated with phenyltriethoxysilane, sodium montmorillonite treated with n-octadecyltriethoxysilane, sodium montmorillonite treated with n-octyltriethoxysilane, and mixtures thereof.

23-30. (canceled)

31. A nanocomposite material adapted for use as at least one of an automotive interior body material and an automotive exterior body material, the nanocomposite material comprising:
at least one polymeric material, wherein the at least one polymeric material comprises thermoplastic olefins including at least one of polypropylene homopolymers, impact modified polypropylenes, ethylene-propylene elastomers, and mixtures thereof; and
at least one modified nanofiller material having shielded polar groups, wherein the at least one polymeric material is compatible with the modified nanofiller without an external compatibilizing material, and wherein the modified nanofiller is a modified clay which is at least one of smectite, hectorite, montmorillonite, bentonite, beidellite, saponite, stevensite, sauconite, nontronite, illite, and mixtures thereof;
wherein the nanocomposite material exhibits enhanced physical properties; and
wherein the nanocomposite material has a flexural modulus ranging between about 814 MPa and about 2144 MPa, and a transmission electron microscopy mean free path ranging between about 0.23 and about 0.64.

32. The nanocomposite material as defined in claim 31, wherein the modified nanofiller is at least one of sodium montmorillonite treated with phenyltriethoxysilane, sodium montmorillonite treated with n-octadecyltriethoxysilane, sodium montmorillonite treated with n-octyltriethoxysilane, and mixtures thereof.

33. The nanocomposite material as defined in claim 32, wherein the nanocomposite material shrinks less than a nanofilled material containing the at least one polymeric material, an organoclay, and an external compatibilizing material, shrink being measured about 48 hours after molding the nanocomposite material; and wherein the organoclay is a sodium montmorillonite clay treated with dimethyl, dihydrogenated tallow quaternary ammonium chloride.

34. A nanocomposite material, comprising:
at least one polymeric material; and
a silanated clay composition, wherein the silanated clay composition is made by a method comprising:
combining a clay with water to form an aqueous clay slurry;
contacting the aqueous clay slurry with an acid to form an acid treated clay slurry; and
contacting the acid treated clay slurry with a silicon compound to form an aqueous silicon treated clay slurry;
wherein the at least one polymeric material is compatible with the silanated clay composition without an external compatibilizing material; and
wherein the nanocomposite material exhibits enhanced physical properties.

35. The nanocomposite material of claim 34, wherein the silanated clay composition comprises a silanated organoclay composition.

36. The nanocomposite material of claim 35, wherein the method further comprises contacting the aqueous silicon treated clay slurry with an onium compound to form a silanated organoclay composition.

37. The nanocomposite material of claim 34, wherein contacting the aqueous clay slurry with an acid comprises adjusting the pH of the aqueous clay slurry to a pH value of less than 7.

38. The nanocomposite material of claim 34, wherein the method further comprises contacting the silicon compound with a surfactant in water to form an emulsion, wherein contacting the acid treated clay slurry with a silicon compound comprises contacting the acid treated clay slurry with the emulsion.

39. (canceled)

40. The nanocomposite material of claim 34, wherein the polymeric material comprises one or more thermoplastic materials.

41. (canceled)

42. The nanocomposite material of claim 34, wherein the polymeric material comprises at least one of polypropylene homopolymers, impact modified polypropylenes, ethylene-propylene elastomers, and mixtures thereof.

43. The nanocomposite material of claim 34, wherein the clay comprises at least one of smectite, hectorite, montmorillonite, bentonite, beidellite, saponite, stevensite, sauconite, nontronite, illite, or mixtures thereof.

44. The nanocomposite material of claim 34, wherein the silicon compound comprises the general formula:
Rₙ—Si—(X)₄₋ₙ
wherein n represents an integer from 1 to 3, wherein R represents an alkyl group, an aryl group, or an alkylaryl group and wherein X represents an alkoxy group, an aryloxy group, an amino group or a halogen.

45-49. (canceled)

50. The nanocomposite material of claim 34, wherein the nanocomposite material has a flexural modulus ranging between about 814 MPa and about 2144 MPa.

51. (canceled)

52. (canceled)

53. The nanocomposite material of claim 34, wherein the nanocomposite material shrinks less than a nanocomposite material comprising the at least one polymeric material, an organoclay, and an external compatibilizing material, shrink being measured about 48 hours after molding the nanocomposite material.

54-57. (canceled)

58. The nanocomposite material of claim 34, wherein the nanocomposite material has a transmission electron microscopy mean free path ranging from about 0.23 to about 0.64.

59. (canceled)

60. The nanocomposite material of claim 34, wherein the nanocomposite material has an aspect ratio ranging from about 50 to about 200.

61. (canceled)

62. The nanocomposite material of claim 34, wherein upon molding the nanocomposite material into a member having a surface, the surface is substantially free from surface defects.

63-70. (canceled)
